(19) United States
(12) Patent Application Publication
(10) Pub. No.: US 2014/0192860 A1
(43) Pub. Date: Jul. 10, 2014

(54) METHOD, DEVICE, COMPUTER PROGRAM, AND INFORMATION STORAGE MEANS FOR ENCODING OR DECODING A SCALABLE VIDEO SEQUENCE

(71) Applicant: CANON KABUSHIKI KAISHA, Tokyo (JP)

(72) Inventors: Patrice ONNO, RENNES (FR); Christophe GISQUET, RENNES (FR); Guillaume LAROCHE, MELESSE (FR); Edouard FRANCOIS, BOURG DES COMPTES (FR)

(73) Assignee: CANON KABUSHIKI KAISHA, Tokyo (JP)

(21) Appl. No.: 14/146,509

(22) Filed: Jan. 2, 2014

(30) Foreign Application Priority Data
Jan. 4, 2013 (GB) 1300148.2
Jan. 9, 2013 (GB) 1300380.1
Jul. 5, 2013 (GB) 1312104.1

(51) Int. Cl. H04N 19/132

(52) U.S. Cl. CPC H04N 19/00127
USPC 375/240.02

(57) ABSTRACT

The invention relates to a method of encoding or decoding a scalable video sequence of frames encoded in a bit-stream made of at least one lower layer and one upper layer, the method comprising:
decoding a lower layer bitstream to obtain first sample adaptive offset, SAO, parameters defining a first SAO filtering applied to at least one lower layer frame area; and
decoding an upper layer bitstream into at least one decoded upper layer frame area, using a second SAO filtering applied to at least one processed frame area of a processed frame based on respective second SAO parameters;
wherein at least one flag in the bit-stream indicates that part or all of the second SAO parameters are inferred from the first SAO parameters

### FIELD OF THE INVENTION

The invention relates to the field of scalable video coding, for example to scalable video coding that would extend the High Efficiency Video Coding (HEVC) standard. The invention concerns a method, device, non-transitory computer-readable medium for encoding or decoding a scalable video sequence made of at least one lower layer, generally a base layer, and one upper layer, generally an enhancement layer.

### BACKGROUND OF THE INVENTION

Many video compression formats, such as for example H.263, H.264, MPEG-1, MPEG-2, MPEG-4, SVC, use block-based discrete cosine transform (DCT) and motion compensation to remove spatial and temporal redundancies. They are often referred to as predictive video formats. Each frame or image in the video signal is identified with an index known as the POC (standing for “picture order count”). Each frame or image is divided into at least one slice which is encoded and can be decoded independently. A slice is typically a rectangular portion of the frame, or more generally, a portion of a frame or an entire frame. Further, each slice may be divided into macroblocks (MBs), and each macroblock is further divided into blocks, typically blocks of 64×64, 32×32, 16×16 or 8×8 pixels.

In High Efficiency Video Coding (HEVC), blocks of from 64×64 to 4×4 may be used. The partitioning is organized according to a quad-tree structure based on largest coding units (LCUs). An LCU corresponds, for example, to a square block of 64×64. If an LCU needs to be divided, a split flag indicates that the LCU is split into four 32×32 blocks. In the same way, if any of these four blocks need to be split, the split flag is set to true and the 32×32 block is divided into four 16×16 blocks etc. When a split flag is set to false, the current block is a coding unit CU which is the frame entity to which the encoding process described below is applied. A CU has a size equal to 64×64, 32×32, 16×16 or 8×8 pixels.

Each CU can be further split into four or more transform units, TUs, which are the frame entities on which DCT and quantization operations are performed. A TU has a size equal to 32×32, 16×16, 8×8 or 4×4 pixels.

There are two families of coding modes for coding blocks of an image: coding modes based on spatial prediction, referred to as INTRA prediction and coding modes based on temporal prediction, referred to as INTER prediction. In both spatial and temporal prediction modes, a residual is computed by subtracting the predictor from the original block.

An INTRA block is generally predicted by an INTRA prediction process from the encoded pixels at its causal boundary. In INTRA prediction, a prediction direction is encoded.

Temporal prediction consists in finding in a reference frame, either a previous or a future frame of the video sequence, an image portion or reference area which is the closest to the block to be encoded. This step is typically known as motion estimation. Next, the block to be encoded is predicted using the reference area in a step typically referred to as motion compensation—the difference, known as residual, between the block to be encoded and the reference portion is encoded in a bitstream, along with an item of motion information relative to the motion vector which indicates the reference area to use for motion compensation. In temporal prediction, at least one motion vector is encoded.

Effective coding chooses the best coding mode between INTER and INTRA coding for each coding unit in an image to provide the best trade-off between image quality at the decoder and reduction of the amount of data to represent the original data to encode.

The residual resulting from the prediction is then subject to DCT transform and quantization.

Both encoding and decoding processes involve in general a decoding process of an encoded image. This process called close loop decoding, is typically performed at the encoder side for the purpose of producing the same reference frames at the encoder than those used by the decoder during the decoding process.

To reconstruct the encoded frame, the residual is inverse quantized and inverse transformed in order to provide the “decoded” residual in the pixel domain. The “decoded” residual is added to the spatial or temporal predictor used above, to obtain a first reconstruction of the frame.

The first reconstruction is then filtered by one or several kinds of post filtering processes. These post filters are applied on the reconstructed frame at the encoder side and the decoder side again in order that the same reference frame is used at both sides.

The aim of this post filtering is to remove compression artifacts and improve image quality. For example, H.264/AVC uses a deblocking filter. This filter can remove blocking artifacts due to the DCT quantization of residual and to block motion compensation. These artifacts are visually important at low bitrates. The deblocking filter operates to smooth the block boundaries according to the characteristics of two neighboring blocks. In the current HEVC standard, two types of loop filters are used generally consecutively: deblocking filter and sample adaptive offset (SAO).

The aim of the SAO loop filter is to improve frame reconstruction by sending additional data as opposed to a deblocking filter where no information is transmitted.

A context of the invention is the design of the scalable extension of HEVC. HEVC scalable extension aims at allowing coding/decoding of a video made of multiple scalability layers, each layer being made of a series of frames.

These layers comprise a base layer that is often compliant with standards such as HEVC, H.264/AVC or MPEG2, and one or more enhancement layers, coded according to the future scalable extension of HEVC.

It is known that to obtain good scalable compression efficiency, one has to exploit information coming from a lower layer, in particular from the base layer, when encoding an upper enhancement layer. For example, SVC standard already implements exploiting redundancy that lies between the base layer and the enhancement layer, through so-called inter-layer prediction techniques. In SVC, a block of an enhancement frame in the enhancement layer may be predicted from the spatially corresponding (i.e. co-located) block of a temporally-coinciding base frame in the decoded base layer. This is known as the Intra Base Layer (BL) prediction mode.

To offer improved reconstruction or decoding of the enhancement layer, filtering process is provided when decoding enhancement layer frame areas, such as LCUs or blocks, to generate decoded enhancement layer frame areas.

For example, contribution “Description of high efficiency scalable video coding technology proposal by Samsung and Vidyo” (Ken MacCann et al., JCTVC-K0044, 11^{th} Meeting: Shanghai, Conn., 10-19 Oct. 2012) discloses a scalable extension of HEVC in which an up-sampled decoded base layer used for encoding/decoding the enhancement layer is subject to SAO loop filtering.

In this contribution, SAO parameters defining the SAO loop filtering for the whole up-sampled decoded base layer are computed from scratch.

Conventional SAO filtering uses a rate distortion criterion to find the best SAO parameters, e.g. SAO filtering type, Edge Offset direction or Band Offset start, offsets. Usually such rate distortion criterion cannot be implemented at the decoder.

Implementing a SAO loop filtering at the encoder thus requires that the corresponding SAO parameters are transmitted in the bitstream to the decoder. Since SAO parameters are determined for each frame area, often each LCU, a great number of SAO parameters has to be transmitted.

This has a non-negligeable rate cost with regards to the transmitted bitstream, but also requires a SAO memory buffer that is sufficiently sized at the decoder to receive and store useful SAO parameters.

### SUMMARY OF THE INVENTION

The present invention has been devised to address at least one of the foregoing concerns, in particular to provide SAO loop filtering at the enhancement layer level while limiting the rate cost at the bitstream level.

According to a first aspect of the invention, there is provided a method of encoding or decoding a scalable video sequence made of at least one lower layer and one upper layer, the method comprising:

decoding a lower layer bitstream to obtain first sample adaptive offset, SAO, parameters defining a first SAO filtering applied to at least one lower layer frame area; and

decoding an upper layer bitstream into a decoded upper layer frame area, using a second SAO filtering applied to at least one processed frame area of a processed frame based on respective second SAO parameters;

wherein part or all of the second SAO parameters are inferred from the first SAO parameters.

The method of the invention improves the coding efficiency of SAO, reducing the overhead in the encoded bitstream due to SAO (at the encoder), reducing the memory buffer needed to store SAO parameters (at both the encoder and decoder), and reducing the complexity of the classification of frame areas (e.g. LCUs) or samples (e.g. pixels).

This is achieved by inferring, or deriving, SAO parameters to be used at the upper layer (e.g. the enhancement layer) from the SAO parameters actually used at the lower (e.g. base) layer. This is because inferring some SAO parameters makes it possible to avoid transmitting them.

As further described below, the inferred SAO parameters may include SAO offsets, SAO type for the frame area (Edge or Band Offset SAO or no SAO), SAO-type-depending sub-parameters for the several SAO types (e.g. the direction for Edge Offset SAO, the start of the band for Band Offset SAO), or all or part of these parameters.

In addition, the second SAO filtering may be applied to a wide variety of frames handled at the enhancement (upper) layer level, including a decoded enhancement frame, an up-sampled decoded base frame, a Base Mode prediction frame, a reference enhancement frame and a residual frame at the enhancement level. These several situations are described below with more details.

According to a second aspect of the invention, there is provided a device for encoding or decoding a scalable video sequence made of at least one lower layer and one upper layer, the device comprising:

an internal base decoder configured to decode a lower layer bitstream to obtain first sample adaptive offset, SAO, parameters defining a first SAO filtering applied to at least one lower layer frame area; and

an internal enhancement decoder configured to decode an upper layer bitstream into at least one decoded upper layer frame area, using a second SAO filtering applied to at least one processed frame area of a processed frame based on respective second SAO parameters;

wherein part or all of the second SAO parameters are inferred from the first SAO parameters.

The device provides similar advantages than the above-defined method. Optional features of the method or of the device are defined in the appended claims and summarized below.

In one embodiment, the second SAO parameters used for SAO filtering each processed frame area composing the processed frame are the same as the first SAO parameters used for SAO filtering a corresponding co-located lower layer frame area in a lower layer frame temporally coinciding with the at least one upper layer frame area being decoded.

Generally, this means the same SAO offsets, the same SAO type (Edge or Band Offset SAO) and the same SAO-type-depending sub-parameters (e.g. the direction for Edge Offset SAO, the start of the band for Band Offset SAO) as in the base frame are used, for each frame area (e.g. LCU) of the considered processed frame when encoding/decoding the enhancement layer.

In particular, the considered processed frame area and its co-located base frame area (i.e. frame area in the base frame) are sized according to the spatial scalability ratio between the lower (base) layer and the upper (enhancement) layer. This particularly applies to the any integer spatial scaling (e.g. the dyadic case where the ratio of spatial scalability equals 2). For example, co-located base frame area may is up-scaled to the processed frame resolution in case there are different spatial resolutions between the base layer and the enhancement layer.

As described below with more details, the processed frame encompasses various types of frames that are processed in the decoding loop of the enhancement layer. For purposes of illustration, the processed frame may include an up-sampled version of a decoded base layer frame, a reconstructed Diff mode residual frame, a Base Mode prediction image, a reference enhancement frame and a decoded enhancement frame.

The above embodiment requires very few processing to obtain the second SAO parameters, mainly consisting in retrieving the first SAO parameters.

In another embodiment, the second SAO parameters for SAO filtering a first processed frame area in the processed frame are first by-default SAO parameters when the first SAO parameters applied to a co-located lower layer frame area in a lower layer frame define a SAO filtering of a first type. For example, this makes it possible to avoid applying the same or similar SAO filter to the enhancement layer as the base layer in some cases (when the first type of SAO filter is used). This approach is mainly driven by the fact that the SAO parameters retrieved from the base layer may reveal not to be efficient at the enhancement layer level. For example, the choice of some SAO filters used is closely related to the content itself or the like of the frame area filtered. But often, the content of the co-located frame area in the other layer is substantially different. Thus deriving the SAO filter from the SAO filter used at the base layer is no longer relevant.

This is particularly true in the case where the first type of SAO filtering is a Band Offset SAO filtering. This is because the Band Offset SAO filter shifts the histogram of sample values of the frame area to match the original histogram. However, the histogram of the enhancement layer is obviously not correlated at all with the histogram of the base layer.

The above provisions thus replace SAO parameters with by by-default SAO parameters.

The reverse is appropriate to the Edge Offset SAO type because the latter aims at correcting quantization artifacts along quantization directions while the quantization directions between the base layer and the enhancement layer are highly correlated. In that situation, the inferred second SAO parameters for a second processed frame area in the processed frame is assigned with a SAO filter type taken from the first SAO parameters applied to a co-located lower layer frame area in the lower layer frame, when the SAO filter type of the first SAO parameters is an Edge Offset SAO filtering.

According to a particular feature, the first by-default SAO parameters define no SAO filtering for the first processed frame area. This provision simplifies the SAO filtering at the enhancement layer.

In a variant, the first type of SAO filtering is No SAO, in which case the first by-default SAO parameters preferably define an Edge Offset SAO filtering. This is now explained in a wording allowing combination with the case where the first type is Band Offset SAO type: the second SAO parameters for SAO filtering a first processed frame area in the processed frame are second by-default SAO parameters when a co-located lower layer frame area in a lower layer frame is not subjected to SAO filtering (i.e. No SAO filtering type). This reflects the fact that a rate-distortion trade-off can be different between the base layer and the enhancement layer when estimating the parameters for SAO filtering.

According to a particular feature, the first or second by-default SAO parameters define an Edge Offset SAO filtering. This provision simplifies the filtering at the enhancement layer.

In particular, the processed frame comprises at least one luminance component and one chrominance component, and the first or second by-default SAO parameters define the Edge Offset SAO filtering of the luminance component only and not of the chrominance component. In a very particular embodiment, it may be provided that the first or second by-default SAO parameters for the first processed frame area in the chrominance component define a Band Offset SAO filtering. The above provisions intend to improve video quality. Indeed, the inventors have noticed that the Edge Offset SAO filtering offers best performance when applied to a Luma component instead of a Chroma component, and that the Band Offset SAO filtering offers reverse performance, i.e. best performance when applied to a Chroma component.

According to a particular embodiment that combines the use of (first) by-default SAO parameters in case of first type SAO filtering in co-located frame area of the base layer and the use of (second) by-default SAO parameters in case of no SAO filtering in co-located frame area of the base layer, the first by-default SAO parameters define no SAO filtering and the second by-default SAO parameters define an Edge Offset SAO filtering.

In a variant, the first and second by-default SAO parameters are the same, and may, in one embodiment, define an Edge Offset SAO filtering. This reduces the amount of by-default SAO parameters to transmit, which is even reduced when such by-default parameters are the same for a plurality of frame areas (e.g. the same for all the LCUs belonging to the same slice or frame).

According to a particular embodiment regarding the obtaining of the by-default SAO parameters, the method comprises determining all or part of the first or second by-default SAO parameters from all the processed frame areas in a frame part of the processed frame that are subjected to SAO filtering using such first or second by-default SAO parameters. This makes it possible to compute optimal (e.g. given a rate distortion criterion) SAO parameters for the considered frame areas (e.g. LCUs) within the frame part as a whole (e.g. a slice or the whole frame). Such determining may be performed on both the encoder and the decoder since they both have the same frames to be processed or can be signaled in the bitstream by the encoder at the appropriate level (e.g. slice or frame). In the latter situation the method may comprise including the determined first or second by-default SAO parameters within the upper layer bitstream, i.e. the bitstream that comprises the encoded upper layer frame areas and that is to be sent to the decoder. This is to reduce computational processes at the decoder.

The determining may include determining a SAO filter type (e.g. Edge or Band offset SAO), a filter-type-depending sub-parameter (e.g. direction for Edge Offset SAO and start of band for Band Offset SAO) and corresponding SAO offsets (generally four offsets), or part of these parameters.

For example, the first or second by-default SAO parameters may include predefined offsets and a predefined SAO filter type defining an Edge Offset SAO filtering, and determining all or part of the first or second by-default SAO parameters may comprise determining an Edge Offset direction based on a rate distortion criterion using the predefined offsets and samples of all the processed frame areas in the frame part of the processed frame that are subjected to SAO filtering using the first or second by-default SAO parameters. Here, only the Edge Offset direction is determined from all the LCUs using the same by-default SAO parameters as a whole. This is again to find an optimal SAO filtering given the contents of the LCUs on which the filtering is about to be applied, and while limiting the amount of SAO parameters to transmit.

According to another particular feature, offsets of the first or second by-default SAO parameters depend on a quantization parameter implemented in the decoding of the upper layer bitstream. This implementation is particularly advantageous when the Edge Offset SAO filtering is implemented as the by-default SAO filtering. This is because Edge Offset SAO aims at correcting quantization artifacts. Thus, taking into account the quantization parameter (i.e. the reason of the quantization artifacts) makes it possible to obtain efficient SAO filtering and better video quality.

In yet another embodiment of the invention, inferring the second SAO parameters includes replacing SAO offsets of the first SAO parameters by determined offsets, and keeping a SAO filter type (e.g. Edge or Band Offset SAO or no SAO) and, if any, a filter-type-depending sub-parameter of the first SAO parameters, to obtain the second SAO parameters. This is to offer the opportunity to improve the coding efficiency by adjusting the SAO parameters to the enhancement layer. This advantageously decreases the overhead in the bitstream due to transmitting the offsets since such offsets can be determined or obtained locally by the decoder. In a variant, the filter-type-depending sub-parameter can also be modified with a determined sub-parameter (e.g. by computing again the best Edge Offset direction or Band Offset start given a plurality of frame areas within a frame part considered).

In one particular embodiment, replacing SAO offsets of the first SAO parameters by determined offsets comprises determining the offsets from all the processed frame areas within a frame part of the processed frame that inherit the same SAO filter type and the same filter-type-depending sub-parameter from first SAO parameters of a lower layer frame. For example the SAO offsets to be used for LCUs classified with the Edge Offset SAO type and with a given orientation due to inheritance from the base layer are computed from the values of the samples of all these LCUs. All these LCUs thus will use the same SAO offsets, which makes it possible to reduce overhead in the bitstream. A rate distortion criterion may be used as explained below.

This provision appears to be very helpful to improve coding quality when a quality difference between the base (lower) layer and the enhancement (upper) layer proves to be high.

In another particular embodiment, the determined offsets comprise the same predefined set of SAO offsets dedicated for all the processed frame areas (e.g. LCUs) within a frame part (e.g. slice or the whole frame) of the processed frame.

In particular, the predefined set of offsets may equal the four following offsets {1, 0, 0, −1}. The inventors have observed that using the above four predefined offsets provide, on overall, good results in term of rate distortion costs, regardless the upper layer frame filtered (be it a decoded enhancement frame, an up-sampled decoded base frame, a Base Mode prediction frame as described below, a reference enhancement frame or a residual frame at the enhancement level).

In yet another embodiment of the invention, the second SAO filtering is applied to the first processed frame area independently of neighbouring frame areas in the same processed frame. This is to avoid depending on samples (e.g. pixels) of other frame areas (e.g. other LCUs). This is advantageous, in particular at the decoder level, since reconstruction of these other frame areas (involving costly processing) is avoided. The complexity of the SAO filtering at the decoder is kept low. Padding of missing neighboring samples, for example by copying the samples edging the frame area, may be provided to guarantee the second SAO filtering of each sample of the frame area considered. In a variant, the samples of the frame area that cannot be filtered given the lack of neighboring frame areas can be discarded from SAO filtering.

In yet another embodiment of the invention, decoding an upper layer bitstream comprises performing a restricted number of SAO filtering on the same processed frame area, including the second SAO filtering based on the second SAO parameters. This configuration aims at reducing the processing complexity by avoiding a large number of cascading SAO filtering in the decoding loop. As described below with more detailed, the restricted number is preferably one or two, thus requiring that some optional SAO filtering be disabled if other SAO filtering have been already performed.

As mentioned above, the second SAO filtering may be applied to a wide variety of frames handled at the upper layer level.

In this context, according to an embodiment of the invention, the processed frame includes an upper layer frame reconstructed from the upper layer bitstream during the decoding. This is for example the case of the decoded enhancement frame just before post-filtering. This may also encompass enhancement frames already decoded that are stored as reference images.

In another embodiment of the invention, the processed frame includes an intermediary frame obtained independently of the upper layer bitstream and used to decode the upper layer frame area. This defines a second set of possible processed frames. Such intermediary frames may be inferred from the base layer using inter-layer prediction. For example, the intermediary frame is constructed using a lower layer frame that temporally coincides with the at least one upper layer frame area being decoded.

This is compliant with the Intra BL coding mode, in which case the intermediary frame includes an up-sampled version of a decoded lower layer frame.

This is also compliant with the Base Mode coding mode as explained below, in which case the intermediary frame mixes frame areas extracted from a decoded lower layer frame and frame areas extracted from reference frames of the upper layer using prediction information from the lower layer.

According to a particular feature, the intermediary frame is used as a spatial or temporal predictor for the upper layer frame area being decoded. This is because frame data different from the frame being currently decoded are generally used only as predictor.

According to a third aspect of the invention, there is provided a method of encoding or decoding a scalable video sequence of frames encoded in a bit-stream made of at least one lower layer and one upper layer, the method comprising:

decoding a lower layer bitstream to obtain first sample adaptive offset, SAO, parameters defining a first SAO filtering applied to at least one lower layer frame area; and

decoding an upper layer bitstream into at least one decoded upper layer frame area, using a second SAO filtering applied to at least one processed frame area of a processed frame based on respective second SAO parameters;

wherein at least one flag in the bit-stream indicates that part or all of the second SAO parameters are inferred from the first SAO parameters.

In an embodiment the frame areas are grouped into slices and the flag is encoded at the slice header level.

In an embodiment the flag is encoded at the frame level in a frame header or a picture parameter set.

In an embodiment the second SAO parameters are inferred if a condition on the decoded upper layer frame area is fulfilled.

According to a fourth aspect of the invention, there is provided a device for encoding or decoding a scalable video sequence of frames encoded in a bit-stream made of at least one lower layer and one upper layer, the method comprising:

a mean for decoding a lower layer bitstream to obtain first sample adaptive offset, SAO, parameters defining a first SAO filtering applied to at least one lower layer frame area; and

a mean for decoding an upper layer bitstream into at least one decoded upper layer frame area, using a second SAO filtering applied to at least one processed frame area of a processed frame based on respective second SAO parameters;

wherein at least one flag in the bit-stream indicates that part or all of the second SAO parameters are inferred from the first SAO parameters.

In an embodiment the frame areas are grouped into slices and the flag is encoded at the slice header level.

In an embodiment the flag is encoded at the frame level in a frame header or a picture parameter set.

In an embodiment the second SAO parameters are inferred if a condition on the decoded upper layer frame area is fulfilled.

Another aspect of the invention relates to a non-transitory computer-readable medium storing a program which, when executed by a microprocessor or computer system in a device, causes the device to perform the steps of any one of the above-defined methods.

The non-transitory computer-readable medium may have features and advantages that are analogous to those set out above and below in relation to the method for encoding or decoding a scalable video sequence, in particular that of achieving efficient SAO filtering at the enhancement layer level at low cost.

Another aspect of the invention relates to a device substantially as herein described with reference to, and as shown in, any of FIGS. 15 to 25 of the accompanying drawings.

At least parts of the method according to the invention may be computer implemented. Accordingly, the present invention may take the form of an entirely hardware embodiment, an entirely software embodiment (including firmware, resident software, micro-code, etc.) or an embodiment combining software and hardware aspects which may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium, for example a tangible carrier medium or a transient carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Other particularities and advantages of the invention will also emerge from the following description, illustrated by the accompanying drawings, in which:

FIG. 1 illustrates a standard video encoder, compliant with the HEVC standard for video compression;

FIG. 2 illustrates a block diagram of a decoder, compliant with standard HEVC or H.264/AVC and reciprocal to the encoder of FIG. 1;

FIGS. 3a and 3b graphically illustrate a sample adaptive Edge offset classification of an HEVC process of the prior art;

FIG. 4 graphically illustrates a sample adaptive Band offset classification of an HEVC process of the prior art;

FIG. 5 is a flow chart illustrating steps of a process for determining compensation offsets for SAO Band offset of HEVC;

FIG. 6 is a flow chart illustrating a process to select an SAO offset from a rate-distortion point of view;

FIG. 7 is a flow chart illustrating steps of a method for determining an SAO band position for SAO Band offset of HEVC;

FIG. 8 is a flow chart illustrating steps of a method for filtering a frame area according to an SAO loop filter;

FIG. 9 is a flow chart illustrating steps of a method for reading SAO parameters from a bitstream;

FIG. 10 is a flow chart illustrating steps of a method for reading SAO parameter syntax from a bitstream;

FIG. 11A schematically illustrates a data communication system in which one or more embodiments of the invention may be implemented;

FIG. 11B illustrates an example of a device for encoding or decoding images, capable of implementing one or more embodiments of the present invention;

FIG. 12 illustrates a block diagram of a scalable video encoder according to embodiments of the invention, compliant with the HEVC standard in the compression of the base layer;

FIG. 13 illustrates a block diagram of a scalable decoder according to embodiments of the invention, compliant with standard HEVC or H.264/AVC in the decoding of the base layer, and reciprocal to the encoder of FIG. 12;

FIG. 14 schematically illustrates Inter-layer prediction modes that can be used in the proposed scalable codec architecture;

FIG. 15 is a flow chart illustrating steps of the SAO parameters reading method of FIG. 9 when inferring SAO parameters from the base layer is optionally implemented;

FIG. 16 illustrates the direct derivation of SAO parameters from the base layer;

FIG. 17 is a flow chart illustrating steps of a method for deriving SAO parameters from the base layer, involving modification of some SAO parameters according to a first example;

FIG. 18 illustrates the derivation of SAO parameters from the base layer according to another example;

FIG. 19 illustrates the derivation of SAO parameters from the base layer according to yet another example;

FIG. 20 is a flow chart illustrating steps of a method for deriving SAO parameters from the base layer, involving modification of some SAO parameters according to a second example combining the embodiments of FIGS. 18 and 19;

FIG. 21 illustrates the derivation of SAO parameters from the base layer according to yet another example; and

FIG. 22 is a flow chart illustrating steps of a method for computing a rate distortion cost for an Edge Offset direction.

FIG. 23A is a representation of the GRILP mode

FIG. 23B is a flow chart illustrating the decoding of the GRILP mode

FIG. 24 is a flow chart illustrating a first particular implementation of the GRILP mode

FIG. 25 is a flow chart illustrating a first particular implementation of the GRILP mode

### DETAILED DESCRIPTION OF EMBODIMENTS OF THE INVENTION

As briefly introduced above, the present invention relates to scalable video coding and decoding, and more particularly to the inheritance of all or part of a sample adaptive offsets (SAO) scheme from a lower or base layer to an upper or enhancement layer.

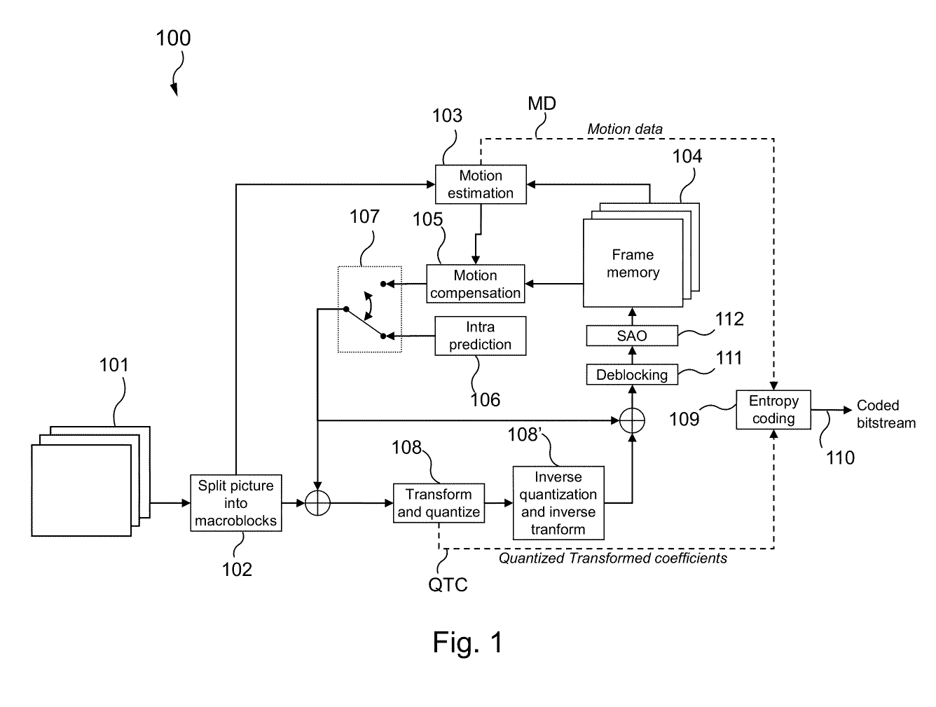

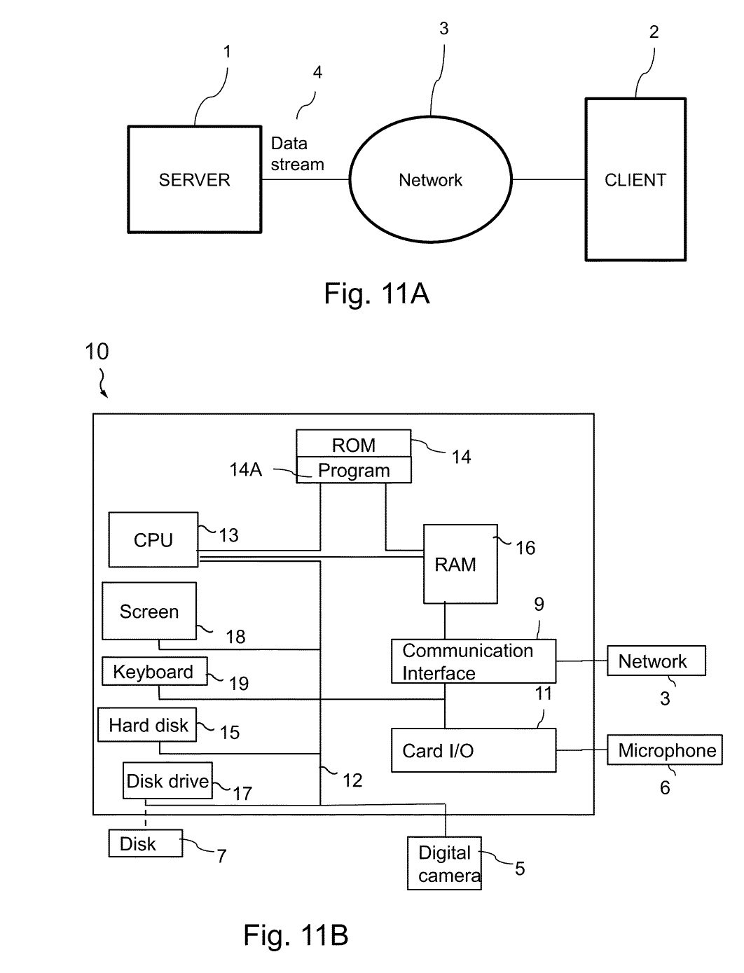

Before describing features specific to the invention, a description of conventional non-scalable encoder and decoder is given with reference to FIGS. 1 to 10, including specific details on conventional SAO loop filtering. Then a description of scalable encoder and decoder is given with reference to FIGS. 11 to 14, in which embodiments of the invention may be implemented.

FIG. 1 illustrates a standard video encoding device, of a generic type, conforming to the HEVC or H.264/AVC video compression system. A block diagram 100 of a standard HEVC or H.264/AVC encoder is shown.

The input to this non-scalable encoder consists in the original sequence of frame images 101 to compress. The encoder successively performs the following steps to encode a standard video bit-stream regarding a particular component, for example a Luma component or a Chroma component.

A first image or frame to be encoded (compressed) is divided into pixel blocks, called coding units (CUs) in the HEVC standard. The first frame is thus split into blocks or macroblocks.

Each block of the frame first undergoes a motion estimation operation 103, which comprises a search, among reference images stored in a dedicated memory buffer 104, for reference blocks that would provide a good prediction of the current block. This motion estimation step provides one or more reference image indexes which contain the found reference blocks, as well as the corresponding motion vectors. A motion compensation step 105 then applies the estimated motion vectors on the found reference blocks and uses it to obtain a residual block that will be coded later on if INTER coding is ultimately selected.

Moreover, an Intra prediction step 106 determines the spatial prediction mode that would provide the best performance to predict the current block and encode it in INTRA mode.

Afterwards, a coding mode selection mechanism 107 chooses the coding mode, among the spatial (INTRA) and temporal (INTER) predictions, which provides the best rate distortion trade-off in the coding of the current block.

The difference between the current block 102 (in its original version) and the prediction block obtained through Intra prediction or motion compensation (not shown) is calculated. This provides the (temporal or spatial) residual to compress.

The residual block then undergoes a transform (DCT) and a quantization 108. The quantization is based on quantization parameters (QP) input by a user. For example a QP is provided at the frame or sequence level (and indicated in a frame header of the bitstream for the decoder). In addition a QP difference, known as ΔQP, is also provided at the frame or sequence level (i.e. indicated in the frame header), and another ΔQP is optionally provided at the CU level (i.e. it is indicated in a header specific to the CU). In use, the QP and ΔQPs are added together to provide a particular QP parameter for each CU, based on which the quantization step is conducted.

Entropy coding 109 of the so-quantized coefficients QTC (and associated motion data MD) is performed. The compressed texture data associated to the coded current block is sent, as a bitstream 110, for output.

Finally, the current block is reconstructed by scaling and inverse transform 108′. This comprises inverse quantization (using the same parameters for quantization) and inverse transform, followed by a sum between the inverse transformed residual and the prediction block of the current block.

Then, the current frame, once reconstructed, is filtered. The current HEVC standard includes one or more in-loop post-filtering processes, selected for example from a deblocking filter 111 and a sample adaptive offset (SAO) filter 112.

The in-loop post-filtering processes aim at reducing the blocking artefact inherent to any block-based video codec, and improve the visual quality of the decoded image (here the reference image in memory 104) and thus the quality of the motion compensation of the following frames.

In the figure, only two post-filtering processes are implemented, namely the deblocking filter 111 and the SAO filter 112.

The post-filtering is generally applied block by block or LCU by LCU (which requires several blocks to be reconstructed before applying the post-filtering) to the reconstructed frame, according to the HEVC standard.

Once the reconstructed frame has been filtered by the two post-filtering, it is stored in the memory buffer 104 (the DPB, Decoded Picture Buffer) so that it is available for use as a reference image to predict any subsequent frame to be encoded.

Finally, a last entropy coding step is given the coding mode and, in case of an INTER coding mode, the motion data MD, as well as the quantized DCT coefficients previously calculated. This entropy coder encodes each of these data into their binary form and encapsulates the so-encoded block into a container called NAL unit (Network Abstract Layer). A NAL unit contains all encoded coding units (i.e. blocks) from a given slice. A coded HEVC bit-stream consists in a series of NAL units.

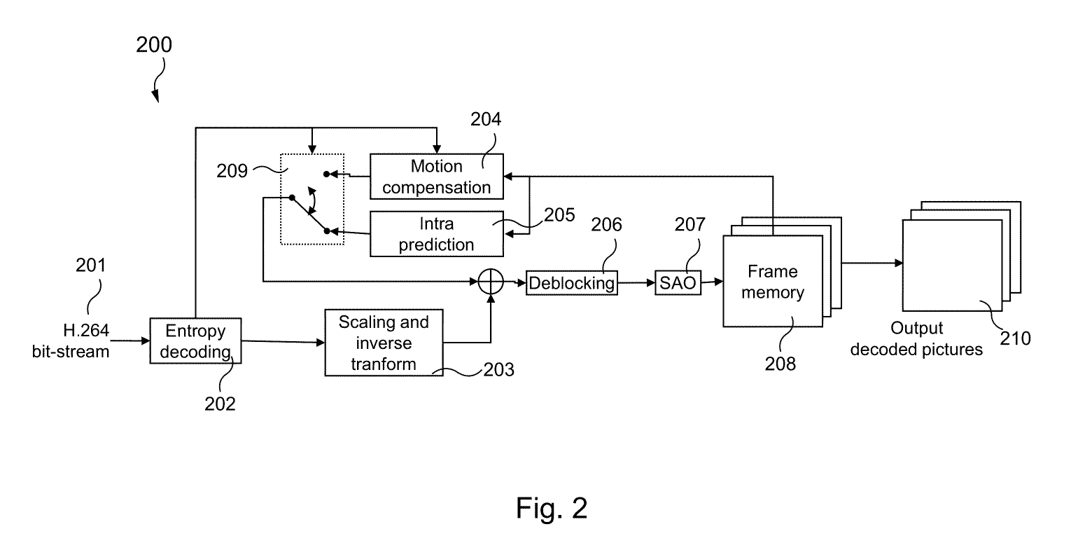

FIG. 2 provides a block diagram of a standard HEVC or H.264/AVC decoding system 200. This decoding process of a H.264 bit-stream 201 starts by the entropy decoding 202 of each block (array of pixels) of each coded frame from the bit-stream. This entropy decoding provides the coding mode, the motion data (reference image indexes, motion vectors of INTER coded macroblocks) and residual data. This residual data consists in quantized and transformed DCT coefficients. Next, these quantized DCT coefficients undergo inverse quantization (scaling) and inverse transform operations 203. The same QP parameters as those used at the encoding are used for the inverse quantization. To be precise, these QP parameters are retrieved from frame and CU headers in the bitstream.

The decoded residual is then added to the temporal 204 or Intra 205 prediction macroblock (predictor) for the current macroblock, to provide the reconstructed macroblock. The choice 209 between INTRA or INTER prediction depends on the prediction mode information which is retrieved from the bitstream by the entropy decoding step.

The reconstructed macroblock finally undergoes one or more in-loop post-filtering processes, e.g. deblocking 206 and SAO filtering 207. Again, the post-filtering is applied block by block or LCU by LCU in the same way as done at the encoder.

The full post-filtered frame is then stored in the Decoded Picture Buffer (DPB), represented by the frame memory 208, which stores images that will serve as references to predict future frames to decode. The decoded frames 210 are also ready to be displayed on screen.

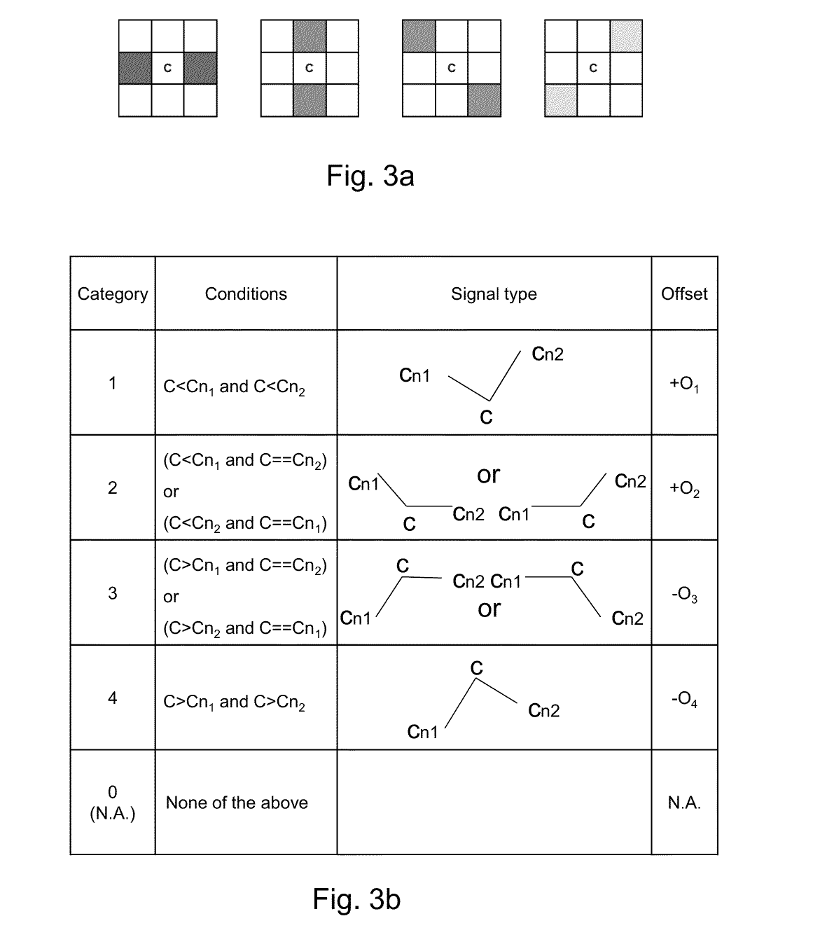

As the present invention regards SAO filtering, details on conventional SAO filtering are now given with reference to FIGS. 3 to 10.

The in-loop SAO post-filtering process aims at improving the quality of the reconstructed frames and requires, contrary to the deblocking filter, to send additional data (SAO parameters) in the bitstream for the decoder to be able to perform the same post-filtering as the encoder in the decoding loop.

The principle of SAO filtering a frame area of pixels is to classify the pixels in classes and to provide correction to the pixels by adding the same offset value or values to the pixel samples having the same class.

SAO loop filtering provides two types of classification for a frame area, in particular for a LCU: Edge Offset SAO type and Band Offset SAO type.

The Edge classification tries to identify the edges form of a SAO partition according to a direction. The Band Offset classification splits the range of pixel values into bands of pixel values.

In order to be more adaptive to the frame content, SAO filtering is applied on several frame areas which divide the current frame into several spatial regions. Currently, frame areas correspond to a finite number of the Largest Coding Unit in HEVC. Consequently, each frame area may or may not be filtered by SAO filtering resulting in only some frame areas being filtered. Moreover, when SAO filtering is enabled for a given frame area, only one SAO classification is used for this frame area: Edge Offset or Band Offset according to the related parameters transmitted for each classification. Finally, for each SAO filtering applied to a frame area, the SAO classification as well as its sub-parameters and the offsets are transmitted. These are the SAO parameters.

An image of video data to be encoded may be provided as a set of two-dimensional arrays (also known as colour channels) of sample values, each entry of which represents the intensity of a colour component such as a measure of luminance intensity and chrominance intensity from neutral grayscale colour toward blue or red (YUV) or as a measure of red, green, or blue light component intensity (RGB). A YUV model defines a colour space in terms of one luma (Y) and two chrominance (UV) components. Generally, Y stands for the luminance component and U and V are the chrominance (color) or chroma components.

SAO filtering is typically applied independently on Luma and on both U and V Chroma components. Below, only one color component is considered. The parameters described below can then be indexed by the color component when several color components are considered.

SAO loop filtering is applied LCU by LCU (64×64 pixels), meaning that the SAO partitioning of the frame and the classification is LCU-based. SAO parameters, including the offsets, the type of SAO classification and possibly SAO-type-depending parameters (e.g. direction of Edge as described below defining a set of categories for the Edge SAO type), are thus generated or selected for each LCU at the encoder side and need to be transmitted to the decoder.

The SAO filtering type selected for each LCU is signalled to the decoder using the SAO type parameter sao_type_idx. Incidentally, this parameter is also used to indicate when no SAO filtering is to be carried out on the LCU. For this reason, the value of the parameter varies from zero to two, for example as follows:

TABLE 1
sao type idx parameter

| sao type idx | SAO type | SAO type meaning |
|---|---|---|
| 0 | none | No SAO filtering is applied on the |
| | | frame area |
| 1 | band | Band offset (band position needed as |
| | | supplemental info) |
| 2 | edge | Edge offset (direction needed as |
| | | supplemental info) |

In case several color components are considered, the parameter is indexed by the color components, for example sao_type_idx_X, where X takes the value Y or UV according to the color component considered (the chroma components are processed in the same way).

Edge offset classification involves determining a class for a LCU wherein for each of its pixels, the corresponding pixel value is compared to the pixel values of two neighboring pixels. Moreover, the two neighboring pixels are selected depending on a parameter which indicates the direction of the two neighboring pixels to be considered. As shown in FIG. 3a, the possible directions for a pixel “C” are a 0-degree direction (horizontal direction), a 45-degree direction (diagonal direction), a 90-degree direction (vertical direction) and a 135-degree direction (second diagonal direction). The directions form the classes for the Edge Offset classification. A direction to be used is given by an SAO-Edge-depending parameter referred to as sao_type_class or sao_eo_class since SAO type=Edge offset (eo) (sao_eo_class_X where X=luma or chroma in case of several color components) in the last drafted HEVC specifications (HM6.0). Its value varies from zero to three, for example as follows:

TABLE 2
sao eo class parameter

| sao eo class (J) | Direction of Edge Offset |
|---|---|
| 0 | 0° |
| 1 | 45° |
| 2 | 90° |
| 3 | 135° |

For the sake of illustration, the offset to be added to a pixel value (or sample) C can be determined, for a given direction, according to the rules as stated in the table of FIG. 3b wherein Cn₁ and Cn₂ designate the value of the two neighboring pixels or samples (according to the given direction).

Accordingly, when the value C is less than the two values Cn₁ and Cn₂, the offset to be added to C is +O₁, when it is less than Cn₁ or Cn₂ and equal to the other value (Cn₁ or Cn₂), the offset to be used is +O₂, when it is greater than Cn₁ or Cn₂ and equal to the other value (Cn₁ or Cn₂), the offset to be used is −O₃, and when it is greater than Cn₁ and Cn₂, the offset to be used is −O₄. When none of these conditions are met, no offset value is added to the current pixel value C.

It is to be noted that according to the Edge Offset mode, only the absolute value of each offset is encoded in the bitstream, the sign to be applied being determined as a function of the category to which the current pixel belongs. Therefore, according to the table shown in FIG. 3b, a positive offset is associated with the categories 1 and 2 while a negative offset is associated with categories 3 and 4. The information about the category of each pixel does not need to be encoded in the bitstream since it is directly retrieved from the pixel values themselves.

Four specific offsets can be provided for each Edge direction. In a variant, the same four offsets are used for all the Edge directions. This is described below.

At the encoder, the selection of the best Edge Offset direction (i.e. of the classification) can be performed based on rate-distortion criterion. For example, starting from a given LCU, the latter is SAO-filtered using a first direction (J=1), the table of FIG. 3B and predetermined offsets as described below, thus resulting in a SAO-filtered LCU. The distortion resulting from the SAO filtering is calculated, for example by computing the difference between the original LCU (from stream 101) and the SAO-filtered LCU and then by computing the L1-norm or L2-norm of this difference.

The distortion for the other directions (J=2, J=3, J=4) and even for class J=N·A (no SAO filtering) are calculating in a similar manner.

The direction/class having the lowest distortion is selected.

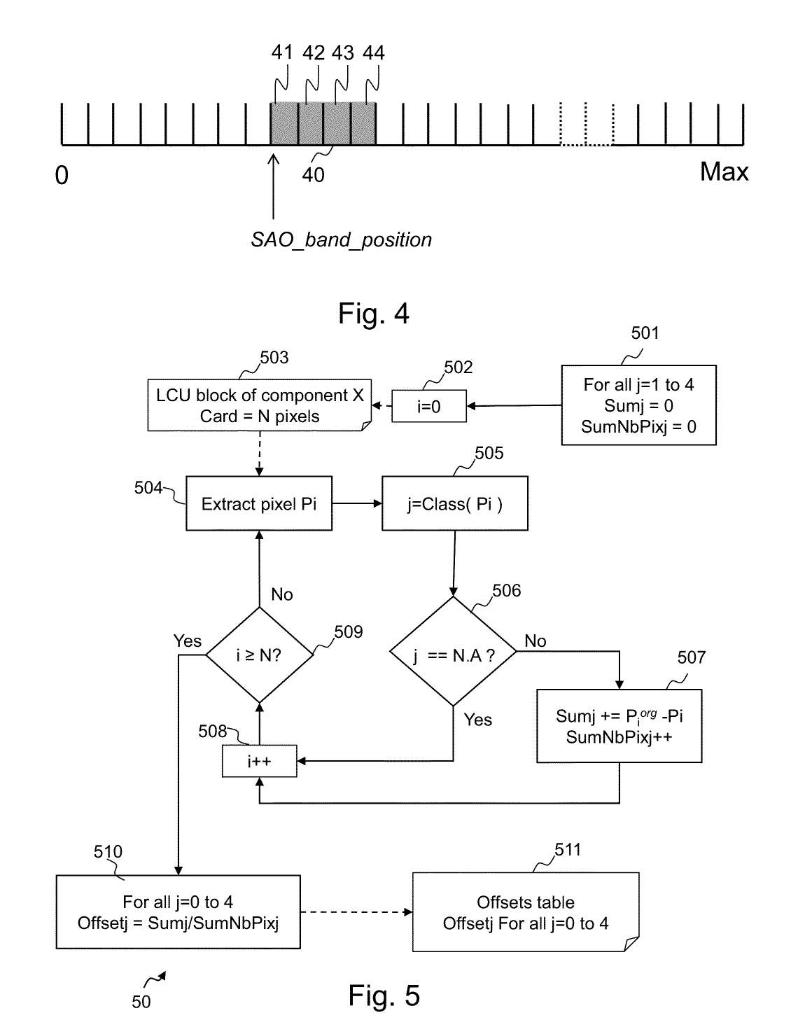

The second type of classification is a Band offset classification which depends on the pixel value. A class in an SAO Band offset corresponds to a range of pixel values. Thus, the same offset is added to all pixels having a pixel value within a given range of pixel values. In the current HEVC specifications, four contiguous ranges of values define four classes with which four respective offsets are associated as schematically shown in FIG. 4. No offset is added to pixels belonging to the other ranges of pixels.

A known implementation of SAO Band offset splits the range of pixel values into 32 predefined ranges of the same size as schematically shown in FIG. 4. The minimum value of the range of pixel values is always zero and the maximum value depends on the bit-depth of the pixel values according to the following relationship Max=2^{Bitdepth}−1.

Splitting the full range of pixel values into 32 ranges enables the use of five bits for classifying each pixel, allowing a fast classification. Accordingly only five bits are checked to classify a pixel in one of the 32 classes or ranges of the full range. This is generally done by checking the five most significant bits, MSBs, of values encoded on 8 bits.

For example, when the bit-depth is 8 bits, the maximum possible value of a pixel is 255. Thus, the range of pixel values is between 0 and 255. For this bit-depth of 8 bits, each class includes a range of 8 pixel values.

The aim of the SAO Band filtering is the filtering of pixels belonging to a group of four consecutive classes or ranges that is defined by the first class. The definition of the first class is transmitted in the bitstream so that the decoder can determine the four consecutive classes or ranges of the pixels to be filtered. A parameter representing the position of the first class is referred to as sao_type_position or sao_band_position (SAO type=Band offset) in the current HEVC specifications.

For the sake of illustration, a group of four consecutive classes or ranges 41 to 44 of pixels to be filtered is represented in FIG. 4 as a grey area. As described above, this group can be identified by its position (i.e. sao_band_position) representing the start of the first class 41, i.e. the value 64 in the depicted example. According to the given example, class or range 41 relates to pixels having values comprised between 64 and 71. Similarly, classes or ranges 42 to 44 relate to pixels having values comprised between 72 and 79, 80 and 87, 88 and 96, respectively.

FIG. 5 is a flow chart illustrating steps of a method for selecting SAO offsets in an encoder for a current frame area 503 (typically an LCU block corresponding to one component of the processed image).

The frame area contains N pixels. In an initial step 501, variables Sumⱼ and SumNbPixⱼ are set to a value of zero for each of the four categories or ranges. j denotes the current range or category number. Sumⱼ denotes the sum of the difference between the value of the pixels in the range/category j and the value of their corresponding original pixels. SumNbPixⱼ denotes the number of pixels in the range j.

The description below is first made with reference to the Edge Offset mode when the direction has been selected (see FIGS. 3a and 3b). A similar approach can be used for the Band Offset mode as also described further below.

In step 502, the counter variable i is set to the value zero to process all the N pixels. Next, the first pixel Pi of the frame area 503 is extracted at step 504 and the category number j corresponding to the current pixel Pi is obtained at step 505. Next, a test is performed at step 506 to determine whether or not the category number j of the current pixel Pi corresponds to the value “N.A.” as described above by reference to the table of FIG. 3b. If the category number j of the current pixel Pi corresponds to the value “N.A.”, the value of counter variable i is incremented by one in order to classify subsequent pixels of the frame area 503. Otherwise, if the category number j of the current pixel Pi does not correspond to the value “N.A.”, the SumNbPixⱼ variable corresponding to the current pixel Pi is incremented by one and the difference between Pᵢ and its original value Pᵢ^{org} is added to Sumⱼ in step 507.

At the following step 508, the counter variable i is incremented by one in order to apply the classification to the other pixels of the frame area 503. At step 509 it is determined whether or not all the N pixels of the frame area 503 have been processed (i.e. is i≧=N?), if yes, an Offsetⱼ for each category is computed at step 510 in order to produce an offset table 511 presenting an offset for each category j as the final result of the offset selection algorithm. This offset is computed as the average of the difference between the pixel values of the pixels of category j and their respective original pixel values. The Offsetⱼ for category j is given by the following equation:

$${Offset}_{j} = \frac{{Sum}_{j}}{{SumNbPix}_{j}}$$

The computed offset Offsetⱼ can be considered as an optimal offset in terms of distortion. It is referred to as Ooptⱼ in the following. From this offset, it is possible to determine an improved offset value O_RDⱼ according to a rate distortion criterion which will be offset Oᵢ of the table in FIG. 3b.

It is to be noted that such a set of four offsets Ooptⱼ is obtained for each direction shown in FIG. 3a with a view of selecting the best direction according to a distortion criterion as explained above.

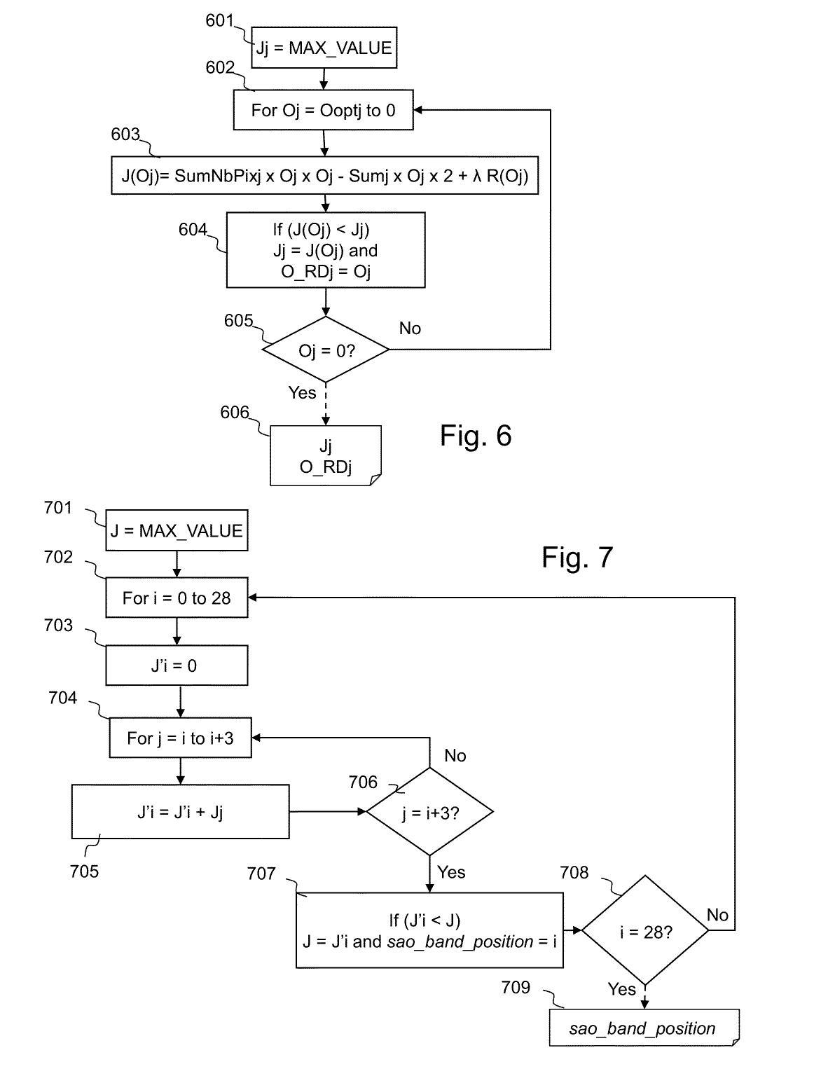

FIG. 6 is a flow chart illustrating steps of a method for determining an improved offset according to a rate distortion criterion starting from Ooptⱼ. This method is performed for each integer j belonging to [1;4].

In an initial step 601, a rate distortion value Jⱼ of the current category number j is initialized to a predetermined maximum possible value (MAX_VALUE).

Next, a loop is launched at step 602 to make offset Oⱼ varying from Ooptⱼ to zero. If value Ooptⱼ is negative, variable Oⱼ is incremented by one until it reaches zero and if value Ooptⱼ is positive, variable Oⱼ is decremented by one until it reaches zero, at each occurrence of step 602.

In step 603, the rate distortion cost related to variable Oⱼ, denoted J(Oⱼ), is computed, for example according to the following formula:

J(0ⱼ)=SumNbPixⱼ×0ⱼ×0ⱼ−Sumⱼ×0ⱼ×2+λR(0ⱼ)

where λ is the Lagrange parameter and R(Oⱼ) is a function which provides the number of bits needed to encode Oⱼ in the bitstream (i.e. the codeword associated with 0). The part of the formula corresponding to SumNbPixⱼ×0ⱼ×0ⱼ−Sumⱼ×0ⱼ×2 relates to the improvement in terms of distortion given by the offset Oⱼ.

In step 604, the values J(Oⱼ) and Jⱼ are compared with each other. If the value J(Oⱼ) is less than the value Jⱼ, then Jⱼ is set to the value of J(Oⱼ) and O_RDⱼ is set to the value of Oⱼ. Otherwise, the process directly goes to the next step 605.

In step 605, it is determined whether or not all the possible values of the offset Oⱼ have been processed (i.e. is Oⱼ=0?). If offset Oⱼ is equal to zero, the loop is ended and an improved offset value (O_RDⱼ) for the category j has been identified with corresponding rate distortion cost Jj. Otherwise, the loop continues with the next Oⱼ value.

It is noted that the algorithm described by reference to FIG. 5 can be used to determine a position of a first range (sao_band_position) according to a Band offset classification type. To that end, index j represents a value of the interval [0, 32] (instead of [1, 4]). In other words, the value 4 is replaced by the value 32 in blocks 501, 510, and 511 of FIG. 5. In addition, “ranges” should be considered instead of “categories” in the explanations above.

More specifically, the difference Sumⱼ between the value of the current pixel and its original value Pᵢ^{Org} can be computed for each of the 32 classes represented in FIG. 4, that is to say for each range j (j belonging to the interval [0, 32]).

Next, an improved offset O_RDⱼ, in terms of rate distortion is computed for the 32 ranges according to an algorithm similar to the one described above with reference to FIG. 6.

Next, the position of the first class is determined as described now with reference to FIG. 7.

FIG. 7 is a flow chart illustrating steps of a method for determining an SAO band position for SAO Band offset of HEVC. Since these steps are carried out after the process described above with reference to FIG. 6, the rate distortion value denoted Jⱼ has already been computed for each range j.

In an initial step 701, the rate distortion value J is initialized to a predetermined maximum possible value (MAX_VALUE). Next, a loop is launched at step 702 to make index i varying from zero to 28, corresponding to the 29 possible positions of the first class of the group of four consecutive classes within the 32 ranges of pixel values.

In step 703, the variable J′ⱼ corresponding to the rate distortion value of the current band, that is to say the band comprising four consecutive classes from the range having the index i, is initialized to zero. Next, a loop is launched at step 704 to make index j vary from i to i+3, corresponding to the four classes of the band currently considered.

Next, in step 705, the value of the variable Jᵢ′ is incremented by the value of the rate distortion value of the class having index j (i.e. by Jⱼ as computed above). This step is repeated for the four classes of the band currently considered, that is to say until index j reaches i+3 (step 706).

In step 707, a test is performed to determine whether or not the rate distortion value J′ⱼ of the band currently considered is less than the rate distortion value J. If the rate distortion value J′ⱼ of the band currently considered is less than the rate distortion value J, the rate distortion value J is set to the value of the rate distortion J′ⱼ of the band currently considered and the band position value denoted sao_band_position is set to the value of the index i, meaning that the band currently considered is currently the best band from amongst all the bands already processed.

These steps are repeated for the 29 possible positions of the first class of the group of four consecutive classes (step 708) to determine the band position (sao_band_position) to be used.

Using the above-described mechanisms, the distortion or rate distortion values for each direction of the Edge Offset mode and for the Band Offset mode have been computed for the same frame area, e.g. LCU. Then, they are compared with each other in order to determine the best one (lowest (rate) distortion value) which is then selected as the SAO filtering mode (sao_type_idx together with sao_eo_class or sao_band_position) for the current frame area.

The SAO parameters, i.e. the SAO type parameter sao_type_idx and, if any, the SAO-type-depending sub-parameter sao_eo_class or sao_band_position and the four offset values are added to the bitstream for each frame area (LCU). The code word to represent each of these syntax elements can use a fixed length code or any method of arithmetic coding.

A particular embodiment of SAO filtering makes it possible to copy SAO parameters for a given LCU from the “up” or “left” LCU, thereby enabling the SAO parameters not to be transmitted.

In order to avoid encoding one set of SAO parameters per LCU (which is very costly), a predictive scheme is used in this embodiment. The predictive mode for SAO parameters consists in checking whether the LCU on the left of the current LCU uses the same SAO parameters or not. In the negative, a second check is performed with the LCU above the current LCU, still checking whether the above LCU uses the same SAO parameters or not.

In the positive of any of the two checks, the SAO parameters as computed above are not added to the bitstream, but a particular flag is enabled, e.g. flag sao_merge_left_flag is set to true or “1” when the first check is positive or flag sao_merge_up_flagis set to true or “1” when the second check is positive.

This predictive technique makes it possible for the amount of data to represent the SAO parameters for the LCU mode in the bitstream to be reduced.

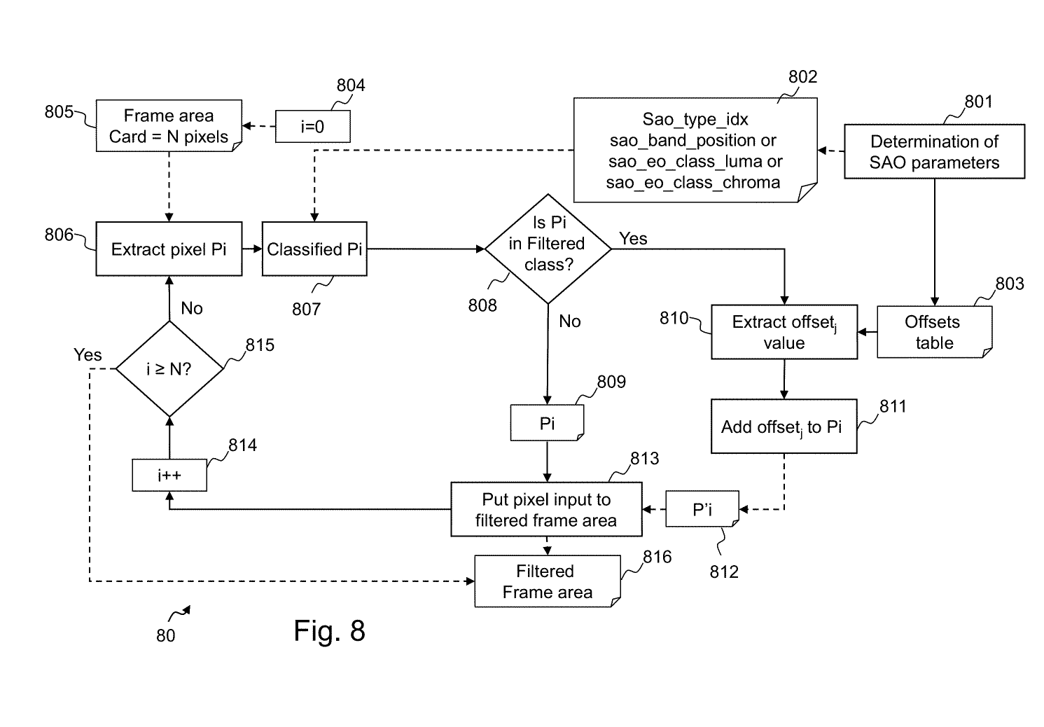

FIG. 8 is a flow chart illustrating steps of a method for filtering a frame area, typically an LCU block corresponding to one component of a processed frame, according to an SAO loop filter.

Such an algorithm is generally implemented in a decoding loop of the decoder to decode frames and of the encoder to generate reference frames that are used for motion estimation and compensation of following frames.

In an initial step 801, SAO filtering parameters are obtained, for example from a received bitstream (decoder) or from the prepared bitstream (encoder) or calculated locally as explained below. For a given frame area, these parameters typically comprise four offsets that can be stored in table 803 and the SAO type parameter sao_type_idx. Depending on the latter, the SAO parameters may further comprise the sao_band_position parameter or the sao_eo_class parameter (802). It is to be noted that a given value of a given SAO parameter, such as the value zero for the sao_type_idx parameter may indicate that no SAO filtering is to be applied.

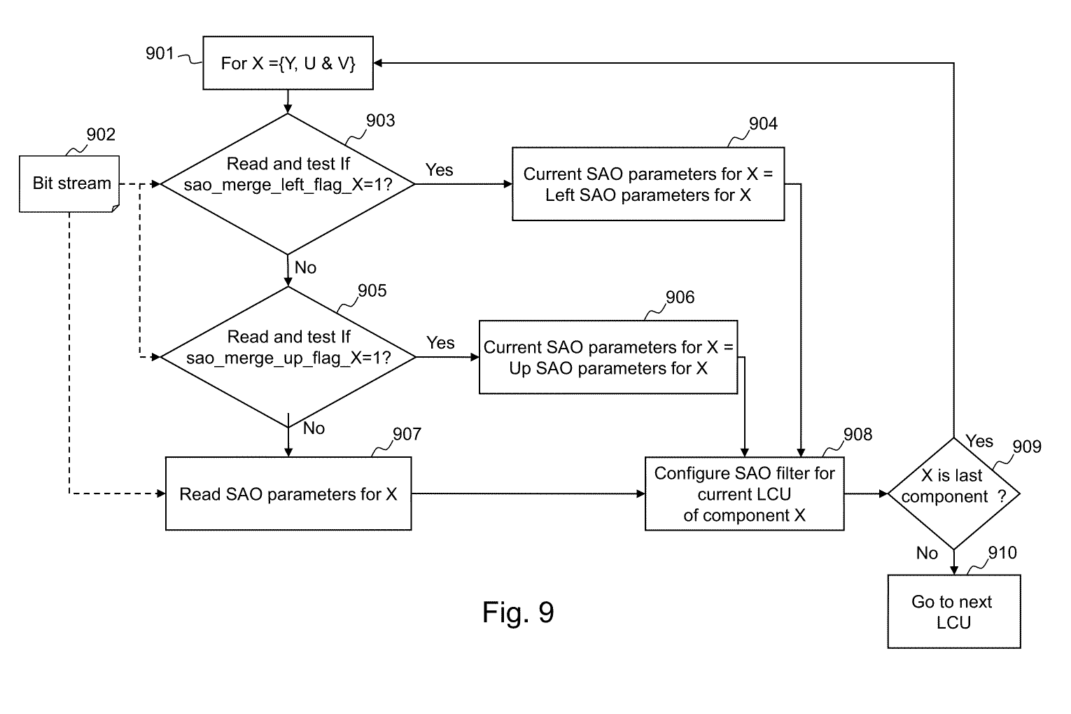

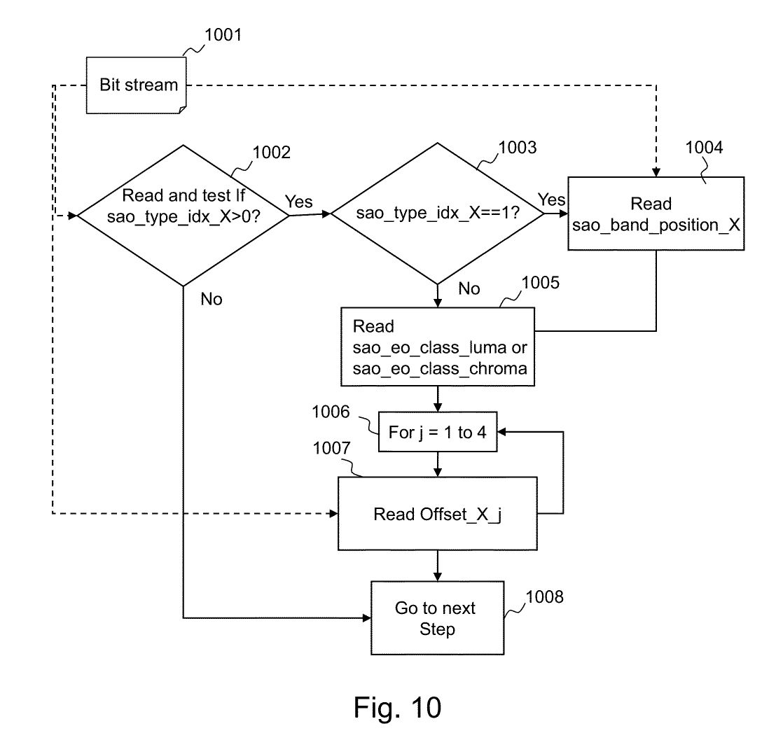

FIGS. 9 and 10 illustrate the initial step 801 of obtaining the SAO parameters from the bitstream.

FIG. 9 is a flow chart illustrating steps of a method for reading SAO parameters from a bitstream.

In step 901, the process starts by selecting a color component of the video sequence. In the current version of HEVC, the parameters are selected for the luma component Y and for both U and V components (together).

In the example of a YUV sequence, the process starts with the Y component.

In step 903, the sao_merge_left_flag is read from the bitstream 902 and decoded. If its value is true or “1”, the next step is 904 where the SAO parameters of left LCU are copied for the current LCU. This enables to determine the type of the SAO filter (sao_type_idx) for the current LCU and its configuration (offsets and sao_eo_class or sao_band_position).

If the answer is negative at 903 then the sao_merge_up_flag is read from the bitstream 902 and decoded. If its value is true or “1”, the next step is 905 where the SAO parameters of above LCU are copied for the current LCU. This enables to determine the type of the SAO filter (sao_type_idx) for the current LCU and its configuration (offsets and sao_eo_class or sao_band_position).

If the answer is negative at step 905, that means that the SAO parameters for the current LCU are not predicted from left or above LCU. They are then read and decoded from the bitstream 902 at step 907 as described below with reference to FIG. 10.

The SAO parameters being known for the current LCU, a SAO filter is configured accordingly at step 908.

The next step is 909 where a check is performed to know if the three color components (Y and U&V) for the current LCU have been processed.

If the answer is positive, the determination of the SAO parameters for the three components is completed and the next LCU can be processed through step 910. Otherwise, only Y has been processed, and U and V are now processed together by going back to step 901.

The parsing and reading 907 of the SAO parameters from the bitstream 902 is now described with reference to FIG. 10.

The process starts at step 1002 by the reading from the bitstream 1001 and decoding of the sao_type_idx syntax element. This makes it possible to know the type of SAO filter to apply to the LCU (frame area) for the color component Y (sao_type_idx_Y) or Chroma U & V (sao_type_idx_UV).

For example, for a YUV 4:2:0 video sequence, two components are considered: one for Y, and one for U and V. Each sao_type_idx_X can take three values as already shown in Table 1 above: 0 correspond to no SAO, 1 corresponds to the Band Offset SAO type and 2 corresponds to the Edge Offset SAO type.

Step 1002 also checks whether the considered sao_type_idx is strictly positive or not.

If sao_type_idx is equal to “0” (which means that there is no SAO for this frame area), the obtaining of the SAO parameters from the bitstream 1001 has been completed and the next step is 1008.

Otherwise (sao_type_idx is strictly positive) SAO parameters exist for the current LCU in the bitstream 1001. Step 1003 thus tests whether the type of SAO filter corresponds to the Band Offset type (sao_type_idx==1).

If it is, the next step 1004 is performed in order to read the bitstream for retrieving the position of the SAO band (sao_band_position) as illustrated in FIG. 4.

If the answer is negative at step 1003 (sao_type_idx is set equal to 2), the SAO filter type is the Edge Offset mode, in which case, at step 1005, the Edge Offset class or direction (sao_eo_class) is retrieved from the bitstream 1001.

If X is equal to Y, the read syntax element is sao_eo_class luma. If X is set equal to UV, the read syntax element is sao_eo_class chroma.

Following step 1004 or 1005, step 1006 drives a loop of four iterations (j=1 to 4). Each iteration consists in step 1007 where the offset Oᵢ with index j is read and decoded from the bitstream 1001. The four offsets obtained correspond either to the four offsets of one of the four classes of SAO Edge Offset or to the four offsets related to the four ranges of the SAO Band Offset. When the four offsets have been decoded, the reading of the SAO parameters has been completed and the next step is 1008 ending the process.

In some embodiments of the invention, SAO parameters are not transmitted in the bitstream because they can be determined by the decoder in the same way as done at the encoder. In this context, local determination of SAO parameters at the decoder should be considered instead of retrieving those parameters from the bitstream.

Back to FIG. 8 where the SAO parameters 802 and 803 have been obtained, the process performs step 804 during which a counter variable i is set to the value zero to process all pixels of the current frame area.

Next, the first pixel Pᵢ of the current frame area 805, comprising N pixels, is obtained at step 806 (as shown in FIG. 1 or 2, it is the result of an internal decoding of a previously encoded frame area) and classified at step 807 according to the SAO parameters 802 read and decoded from the bitstream or obtained locally, i.e. Edge Offset classification or Band Offset classification as described previously.

Next, at step 808, a test is performed to determine whether or not pixel Pᵢ belongs to a valid class, i.e. a class of pixels to be filtered. This is the case if sao_type_idx is 1 or 2 in the above example.

If pixel Pᵢ belongs to a class of pixels to be filtered, its related class number and possible category j are identified (i.e. direction and category in the Edge Offset mode, or start of first class and class in the Band Offset mode) and its related offset value Offsetⱼ is obtained at step 810 from the offsets table 803.

Next, at step 811, Offsetⱼ is added to the value of pixel Pᵢ in order to produce a new pixel value referred to as P′ᵢ (812) which is a filtered pixel. In step 813, pixel P′ᵢ replaces pixel Pᵢ in the processed frame area 816.

Otherwise, if pixel Pᵢ does not belong to a class of pixels to be filtered, pixel Pᵢ 809 remains unchanged in the frame area at step 813.

Next, after having processed pixel Pᵢ, the counter variable i is incremented by one at step 814 in order to apply the filter in the same way as the next pixel of the current frame area 805.

Step 815 determines whether or not all the N pixels of the current frame area 805 have been processed (i≧N). If yes, the processed frame area 816 has been reconstructed as stored in 813, and can be added to the SAO reconstructed frame (104 in FIG. 1 or 208 in FIG. 2) as a subpart thereof.

As defined above, the present invention is dedicated to scalable video coding and decoding wherein SAO filtering is provided at a lower layer and at an upper layer. Before explaining the specific features of the invention, a context of scalable video coding and decoding is first described.

FIG. 11A illustrates a data communication system in which one or more embodiments of the invention may be implemented. The data communication system comprises a sending device, in this case a server 1, which is operable to transmit data packets of a data stream to a receiving device, in this case a client terminal 2, via a data communication network 3. The data communication network 3 may be a Wide Area Network (WAN) or a Local Area Network (LAN). Such a network may be for example a wireless network (Wifi/802.11a or b or g or n), an Ethernet network, an Internet network or a mixed network composed of several different networks. In a particular embodiment of the invention the data communication system may be, for example, a digital television broadcast system in which the server 1 sends the same data content to multiple clients.

The data stream 4 provided by the server 1 may be composed of multimedia data representing video and audio data. Audio and video data streams may, in some embodiments, be captured by the server 1 using a microphone and a camera respectively. In some embodiments data streams may be stored on the server 1 or received by the server 1 from another data provider. The video and audio streams are coded by an encoder of the server 1 in particular for them to be compressed for transmission.

In order to obtain a better ratio of the quality of transmitted data to quantity of transmitted data, the compression of the video data may be of motion compensation type, for example in accordance with the HEVC type format or H.264/AVC type format and including features of the invention as described below.

A decoder of the client 2 decodes the reconstructed data stream received by the network 3. The reconstructed images may be displayed by a display device and received audio data may be reproduced by a loud speaker. Reflecting the encoding, the decoding also includes features of the invention as described below.

FIG. 11B shows a device 10, in which one or more embodiments of the invention may be implemented, illustrated arranged in cooperation with a digital camera 5, a microphone 6 (shown via a card input/output 11), a telecommunications network 3 and a disc 7, comprising a communication bus 12 to which are connected:
a central processing CPU 13, for example provided in the form of a microprocessor
a read only memory (ROM) 14 comprising a program 14A whose execution enables the methods according to an embodiment of the invention. This memory 14 may be a flash memory or EEPROM;
a random access memory (RAM) 16 which, after powering up of the device 10, contains the executable code of the program 14A necessary for the implementation of an embodiment of the invention. This RAM memory 16, being random access type, provides fast access compared to ROM 14. In addition the RAM 16 stores the various images and the various blocks of pixels as the processing is carried out on the video sequences (transform, quantization, storage of reference images etc.);
a screen 18 for displaying data, in particular video and/or serving as a graphical interface with the user, who may thus interact with the programs according to an embodiment of the invention, using a keyboard 19 or any other means e.g. a mouse (not shown) or pointing device (not shown);
a hard disc 15 or a storage memory, such as a memory of compact flash type, able to contain the programs of an embodiment of the invention as well as data used or produced on implementation of an embodiment of the invention;
an optional disc drive 17, or another reader for a removable data carrier, adapted to receive a disc 7 and to read/write thereon data processed, or to be processed, in accordance with an embodiment of the invention and;
a communication interface 9 connected to a telecommunications network 34
connection to a digital camera 5

The communication bus 12 permits communication and interoperability between the different elements included in the device 10 or connected to it. The representation of the communication bus 12 given here is not limiting. In particular, the CPU 13 may communicate instructions to any element of the device 10 directly or by means of another element of the device 10.

The disc 7 can be replaced by any information carrier such as a compact disc (CD-ROM), either writable or rewritable, a ZIP disc or a memory card. Generally, an information storage means, which can be read by a micro-computer or microprocessor, which may optionally be integrated in the device 10 for processing a video sequence, is adapted to store one or more programs whose execution permits the implementation of the method according to an embodiment of the invention.

The executable code enabling the coding device to implement an embodiment of the invention may be stored in ROM 14, on the hard disc 15 or on a removable digital medium such as a disc 7.

The CPU 13 controls and directs the execution of the instructions or portions of software code of the program or programs of an embodiment of the invention, the instructions or portions of software code being stored in one of the aforementioned storage means. On powering up of the device 10, the program or programs stored in non-volatile memory, e.g. hard disc 15 or ROM 14, are transferred into the RAM 16, which then contains the executable code of the program or programs of an embodiment of the invention, as well as registers for storing the variables and parameters necessary for implementation of an embodiment of the invention.

It should be noted that the device implementing an embodiment of the invention, or incorporating it, may be implemented in the form of a programmed apparatus. For example, such a device may then contain the code of the computer program or programs in a fixed form in an application specific integrated circuit (ASIC).

The device 10 described here and, particularly, the CPU 13, may implement all or part of the processing operations described below.

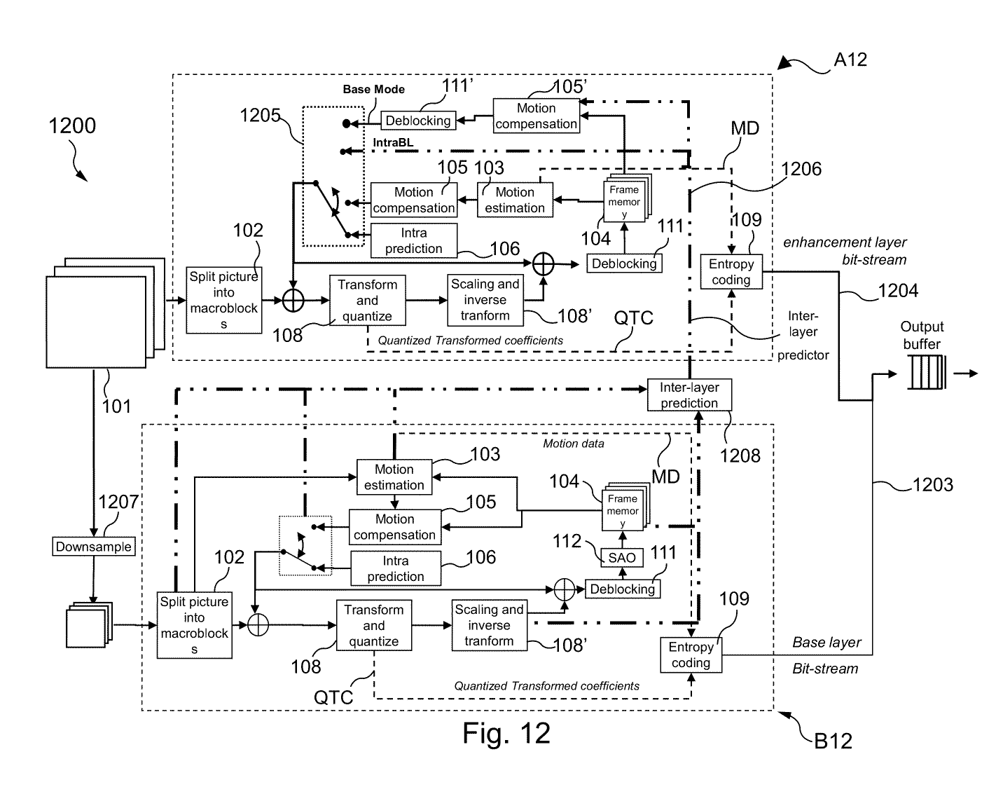

FIG. 12 illustrates a block diagram of a scalable video encoder 1200, which comprises a straightforward extension of the standard video coder of FIG. 1, towards a scalable video coder. This video encoder may comprise a number of subparts or stages, illustrated here are two subparts or stages A12 and B12 producing data corresponding to a base layer 1203 and data corresponding to one enhancement layer 1204. Additional subparts A12 may be contemplated in case other enhancement layers are defined in the scalable coding scheme. Each of the subparts A12 and B12 follows the principles of the standard video encoder 100, with the steps of transformation, quantization and entropy coding being applied in two separate paths, one corresponding to each layer.

The first stage B12 aims at encoding the H.264/AVC or HEVC compliant base layer of the output scalable stream, and hence is identical to the encoder of FIG. 1. Next, the second stage A12 illustrates the coding of an enhancement layer on top of the base layer. This enhancement layer brings a refinement of the spatial resolution to the (down-sampled 1207) base layer.

As illustrated in FIG. 12, the coding scheme of this enhancement layer is similar to that of the base layer, except that for each block or coding unit of a current frame 101 being compressed or coded, additional prediction modes can be chosen by the coding mode selection module 1205.

The additional prediction and coding modes implement inter-layer prediction 1208. Inter-layer prediction 1208 consists in re-using data coded in a layer lower than current refinement or enhancement layer (e.g. base layer), as prediction data of the current coding unit.

The lower layer used is called the reference layer for the inter-layer prediction of the current enhancement layer. In case the reference layer contains a frame that temporally coincides with the current enhancement frame to encode, then it is called the base frame of the current enhancement frame. As described below, the co-located block (at same spatial position) of the current coding unit that has been coded in the reference layer can be used to provide data in view of building or selecting a prediction unit or block to predict the current coding unit. More precisely, the prediction data that can be used from the co-located block includes the coding mode, the block partition or break-down, the motion data (if present) and the texture data (temporal residual or reconstructed block) of that co-located block. In case of spatial scalability between the enhancement layer and the base layer, some up-sampling operations of the texture and prediction data are performed.

As described above, in the decoding loop of the subpart B12, SAO post-filtering 112 (and optionally deblocking 111) is provided to the decoded frame (LCU by LCU) to generate filtered base frames 104 used as reference frames for future prediction. SAO parameters are thus produced at the base layer B12 as explained above with reference to FIGS. 3 to 7, and are added to the base layer bit-stream 1203 for the decoder.

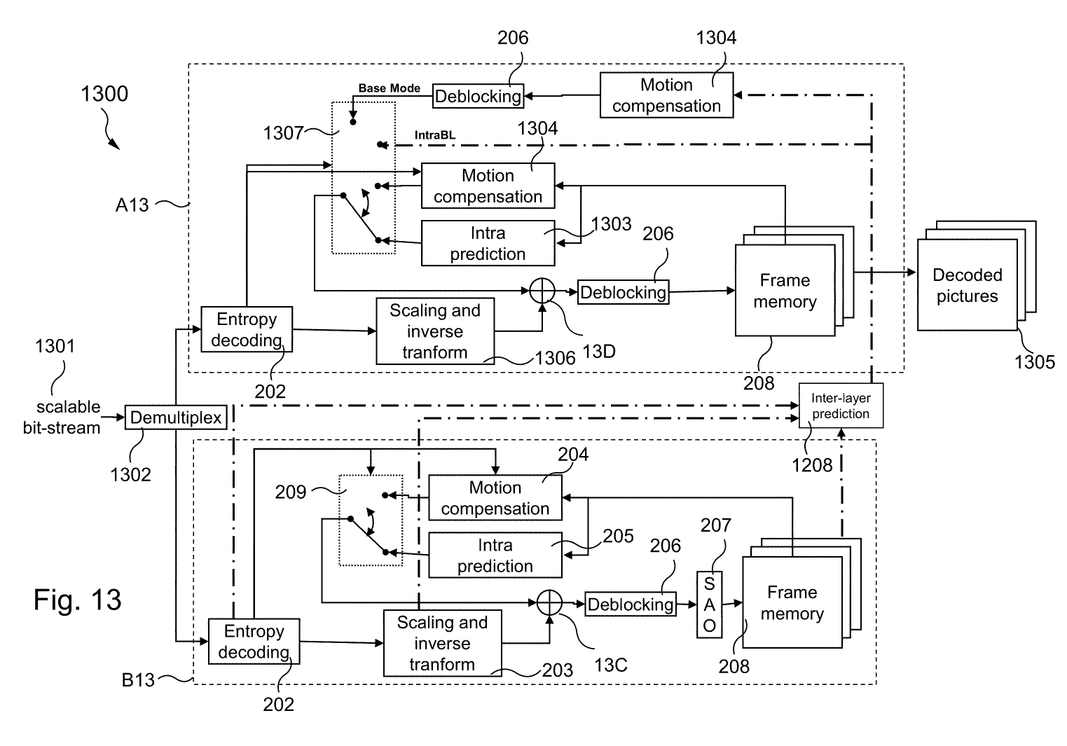

FIG. 13 presents a block diagram of a scalable video decoder 1300 which would apply on a scalable bit-stream made of two scalability layers, e.g. comprising a base layer and an enhancement layer, for example the bit-stream generated by the scalable video encoder of FIG. 12. This decoding process is thus the reciprocal processing of the scalable coding process of the same Figure. The scalable bit-stream being decoded 1301, as shown in FIG. 13 is made of one base layer and one spatial enhancement layer on top of the base layer, which are demultiplexed 1302 into their respective layers.

The first stage of FIG. 13 concerns the base layer decoding process B13. As previously explained for the non-scalable case, this decoding process starts by entropy decoding 202 each coding unit or block of each coded image in the base layer from the base layer bitstream (1203 in FIG. 12). This entropy decoding 202 provides the coding mode, the motion data (reference image indexes, motion vectors of Inter coded macroblocks) and residual data. This residual data consists of quantized and transformed DCT coefficients. Next, these quantized DCT coefficients undergo inverse quantization and inverse transform operations 203. Motion compensation 204 or Intra prediction 205 data can be added 13C.

Deblocking 206 and SAO filtering 207 are performed on the decoded data (LCU by LCU), in particular by reading SAO parameters from the bitstream 1301 as explained above with reference to FIGS. 8 to 10 and/or by determining some SAO parameters locally. The so-reconstructed residual data is then stored in the frame buffer 208.

Next, the decoded motion and temporal residual for Inter blocks, and the reconstructed blocks are stored into a frame buffer in the first stage B13 of the scalable decoder of FIG. 13. Such frames contain the data that can be used as reference data to predict an upper scalability layer.

Next, the second stage A13 of FIG. 13 performs the decoding of a spatial enhancement layer A13 on top of the base layer decoded by the first stage. This spatial enhancement layer decoding involves the entropy decoding of the second layer 202 from the enhancement layer bitstream (1204 in FIG. 12), which provides the coding modes, motion information as well as the transformed and quantized residual information of blocks of the second layer.

Next step consists in predicting blocks in the enhancement image. The choice 1307 between different types of block prediction modes (those suggested above with reference to the encoder of FIG. 12—conventional INTRA coding mode, conventional INTER coding mode or Inter-layer coding modes) depends on the prediction mode obtained through the entropy decoding step 202 from the bitstream 1301.

The result of the entropy decoding 202 undergoes inverse quantization and inverse transform 1306, and then is added 13D to the obtained prediction block.

The obtained block is optionally post-processed 206 (if the same has occurred in A12 at the encoder level) to produce the decoded enhancement image that can be displayed and are stored in reference frame memory 208.

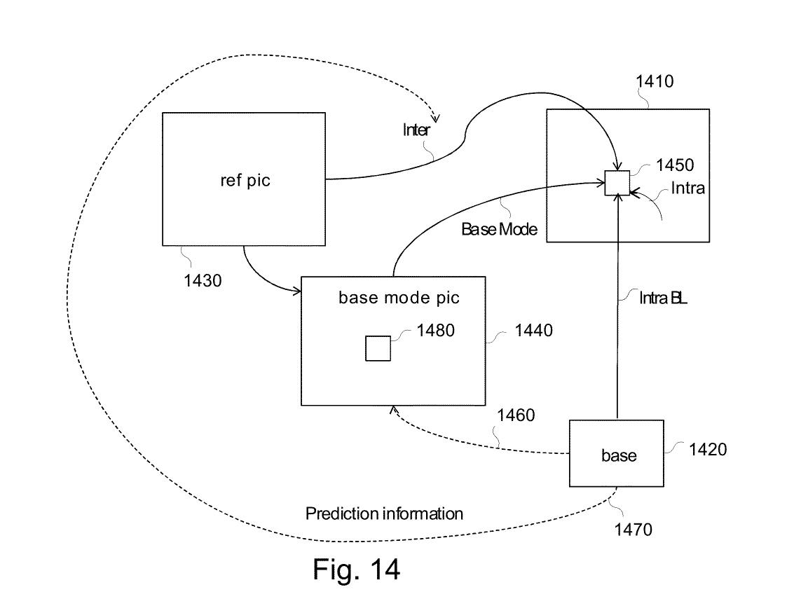

FIG. 14 schematically illustrates Inter-layer prediction modes that can be used in the proposed scalable codec architecture, according to an embodiment, for prediction of a current enhancement image.

Schematic 1410 corresponds to the current enhancement frame to be predicted. The base frame 1420 corresponds to the base layer decoded image that temporally coincides with the current enhancement frame.

Schematic 1430 corresponds to an exemplary reference frame in the enhancement layer used for the conventional temporal prediction of the current enhancement frame 1410.

Schematic 1440 corresponds to a Base Mode prediction image as further described below.

As illustrated by FIG. 14, the prediction of current enhancement frame 1410 comprises determining, for each block 1450 in current enhancement frame 1410, the best available prediction mode for that block 1450, considering prediction modes including spatial prediction (INTRA), temporal prediction (INTER), Intra BL prediction and Base Mode prediction.

Briefly, the Intra BL (Base Layer) prediction mode consists in predicting a coding unit or block 1450 of the enhancement frame 1410 using its co-located decoded frame area (in an up-sampled version in case of spatial scalability) taken from the decoded base frame 1420 that temporally coincides with frame 1410. Intra BL mode is known from SVC (Scalable Video Coding).

In practice, to avoid complexity in processing the data (in particular to avoid storing large amount of data at the decoder), the up-sampled version of the decoded base frame 1420 is not fully reconstructed at the decoder. Only the blocks of 1420 that are necessary as predictors for decoding are reconstructed.

The Base Mode prediction mode consists in predicting a block of the enhancement frame 1410 from its co-located block 1480 in the Base Mode prediction image 1440, constructed both on the encoder and decoder sides using data and prediction data from the base layer.

The base mode prediction image 1440 is composed of base mode blocks obtained using prediction information 1460 derived from prediction information of the base layer. In more details, for each base mode block forming the base mode prediction image, the co-located base block in the corresponding base frame 1420 is considered.

If that co-located base block is intra coded, the base mode block directly derives from the co-located base block, for example by copying that co-located base block, possibly up-sampled in case of spatial scalability between the base layer and the enhancement layer.

If the co-located base block is inter coded into a base residual using prediction information in the base layer, the base mode block derives from a prediction block of reference frame 1430 in the enhancement layer and from a decoded version (up-sampled in case of spatial scalability) of the base residual, which prediction block is obtained by applying a motion vector (up-sampled in case of spatial scalability) of the prediction information to the base mode block. The prediction block and the decoded base residual are for example added one to the other.

In practice, to avoid complexity in processing the data (in particular to avoid storing large amount of data at the decoder), the base mode prediction image 1440 is not fully reconstructed at the decoder. Only the base mode blocks that are necessary as predictors for decoding are reconstructed.

One can note also that in another implementation of the base mode prediction mode, no base mode prediction image is constructed at the encoder. The base mode predictor of a current block in the enhancement layer is constructed just by using the motion information of the co-located frame area in the base layer frame. The so constructed base mode predictor can be enhanced by predicting the current block residual from the residual of the co-located block in the base layer.

A deblocking 206 of the base mode prediction image 1440 is optionally implemented before the base mode prediction image is used to provide prediction blocks for frame 1410.

Given these two additional Inter-layer coding modes (one is Intra coding, the other involves temporal reference frames), addition step 13D at the enhancement layer for current block 1450 consists in adding the reconstructed residual for that block (after step 1306) with:
a spatial predictor block taken from current enhancement frame 1410 in case of conventional INTRA prediction;
an upsampled decoded base block taken from base frame 1420 and co-located with block 1450, in case of Intra BL prediction;
a temporal predictor block taken from a reference enhancement frame 1430 (from frame memory 208 in A13) in case of conventional INTER prediction; or
a base mode block 1480 co-located with block 1450 in the base mode prediction image, in case of Base Mode prediction.

These are only two examples of Inter-layer coding modes. Other Inter-layer coding modes may be implemented using the same and/or other information from the base layer. For example, the base layer prediction information may be used in the predictive coding 1470 of motion vectors in the enhancement layer. Therefore, the INTER prediction mode may make use of the prediction information contained in the base image 1420. This would allow inter-layer prediction of the motion vectors of the enhancement layer, hence increasing the coding efficiency of the scalable video coding system.

In the context of scalability, the Generalized Inter-Layer Prediction (GRP or GRILP) mode may be applied to generate the second set of candidate predictors. The difference of this mode compared to the previously described modes is the use of the residual difference between the Enhancement layer and the base layer inserted in the block predictors. Generalized Residual Inter-Layer Prediction (GRILP) involves predicting the temporal residual of an inter coding unit in an enhancement layer, from a temporal residual computed between reconstructed base images. This prediction method, employed in case of multi-loop decoding, comprises constructing a “virtual” residual in the base layer by applying the motion information obtained in the enhancement layer to the coding unit of the base layer co-located with the coding unit to be predicted in the enhancement layer to identify a predictor co-located to the predictor of the enhancement layer.

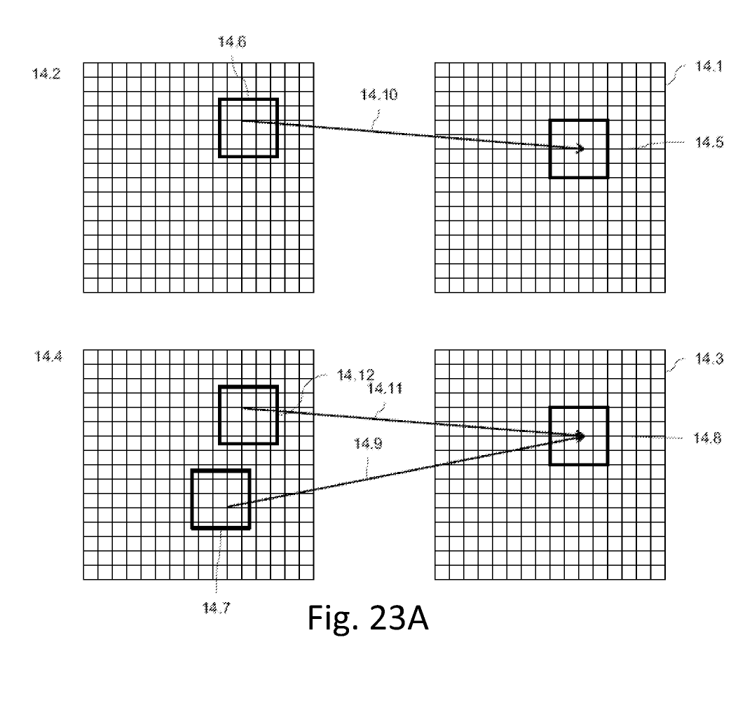

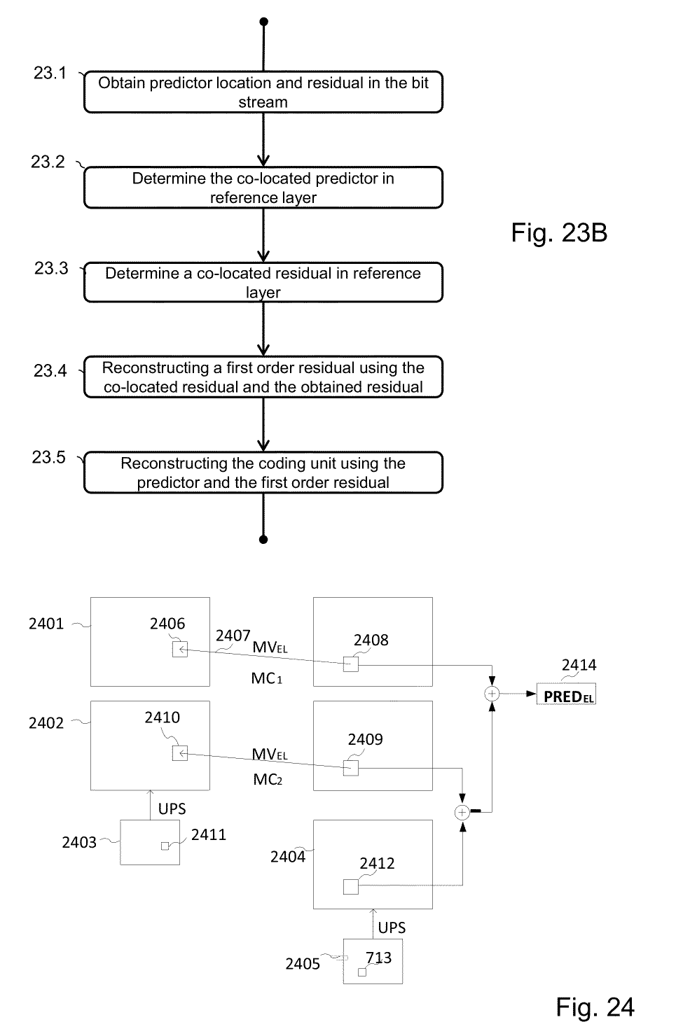

An exemplary mode of GRILP will be described with reference to FIG. 23A. The image to be encoded, or decoded, is the image representation 14.1 in the enhancement layer of FIG. 6A. This image is composed of original pixels. Image representation 14.2 in the enhancement layer is available in its reconstructed version.

In the case where the encoding mode is multi loop, a complete reconstruction of the base layer is conducted. In this case, image representation 14.4 of the previous image and image representation 14.3 of the current image both in the base layer are available in their reconstructed version.

On the encoder side, a selection is made between all available modes in the enhancement layer to determine a mode optimizing a rate-distortion trade off. The GRILP mode is one of the modes which may be selected for encoding a block of an enhancement layer.

In what follows the described GRILP is adapted to temporal prediction in the enhancement layer. This process starts with the identification of the temporal GRILP predictor.

The flowchart of FIG. 23B illustrates steps of a decoding process of the GRILP mode in accordance with an embodiment of the invention. The bit stream comprises for a coding unit encoded with the GRILP mode data for locating the predictor and a second order residual corresponding to the difference between the predictor obtained with the GRILP mode and the original coding unit of the enhancement layer to predict. A second order residual here is a difference between two residuals while a first order residual is the difference between a predictor and a block of data to predict. In an initial step 23.1, the location of the predictor used for the prediction of the coding unit and the associated residual are obtained from the bit stream. In a step 23.2, the co-located predictor is determined. This is the location in the reference layer of the pixels corresponding to the predictor obtained from the bit stream. In a step 23.3, the co-located residual is determined. This co-located residual is a first order residual. and is defined by the difference between the co-located coding unit and the co-located predictor in the reference layer. In a subsequent step 23.4, the first order residual block is reconstructed by adding the residual obtained from the bit stream which corresponds to the second order residual and the co-located residual. Once the first order residual block has been reconstructed, it is then used with the predictor whose location has been obtained from the bit stream to reconstruct the coding unit in a step 23.5. Equation 1.1 expresses the GRILP mode process for generating a EL prediction signal PRED_{EL}:

PRED_{EL}=MC₁[REF_{ER},MV_{EL}]+{UPS[REC_{BL}]−MC₂[UPS[REF_{BL}],MV_{EL}]} (1.1)

In this equation,
PRED_{EL} corresponds to the prediction of the EL coding unit being processed,
REC_{BL} is the co-located block from the reconstructed BL picture, corresponding to the current EL picture,
MV_{EL} is the motion vector used for the temporal prediction in the EL
REF_{ER} is the reference EL picture,
REF_{BL} is the reference BL picture,
UPS[x] is the upsampling operator performing the upsampling of samples from picture x; it applies to the BL samples
MC₁[x,y] is the EL operator performing the motion compensated prediction from the picture x using the motion vector y
MC₂[x,y] is the BL operator performing the motion compensated prediction from the picture x using the motion vector y

This is illustrated in FIG. 24. Considering that the final block in the EL picture is of size H lines×W columns, its corresponding block in the BL picture is of size h lines×w columns. W/w and H/h then correspond to the inter-layer spatial resolution ratios. The block 2408 (of size H×W) is obtained by motion compensation MC1 of a block 2406 (of size H×W) from the reference EL picture REFEL 2401 using the motion vector MVEL 2407. The block 2409 (of size H×W) is obtained by motion compensation MC2 of a block 2410 (of size H×W) of the upsampled reference BL picture 2402 using the same motion vector MVEL 2407. The block 2410 has been derived by upsampling the block 2411 (of size h×w) from the BL reference picture REFBL 2403. The block 2412 (of size H×W), in the upsampled BL picture 2404, is the upsampled version of the block 2413 (of size h×w) from the current BL picture RECBL 2405. Samples of block 2409 are subtracted to samples of block 2412 to generate the second order residual, which is added to the block 2408 to generate the final EL prediction block 2414.

In one particular embodiment, which is advantageous in terms of memory saving, the first order residual block in the reference layer may be computed between reconstructed pictures which are not up-sampled, thus are stored in memory at the spatial resolution of the reference layer.

The computation of the first order residual block in the reference layer then includes a down-sampling of the motion vector considered in the enhancement layer, towards the spatial resolution of the reference layer. The motion compensation is then performed at reduced resolution level in the reference layer, which provides a first order residual block predictor at reduced resolution.

A final inter-layer residual prediction step then involves up-sampling the so-obtained first order residual block predictor, through a bi-linear interpolation filtering for instance. Any spatial interpolation filtering could be considered at this step of the process (examples: 8-Tap DCT-IF, 6-tap DCT-IF, 4-tap SVC filter, bi-linear). This last embodiment may lead to slightly reduced coding efficiency in the overall scalable video coding process, but does not need additional reference picture storing compared to standard approaches as diff mode that do not implement the present embodiment.

This corresponds to the following equation:

PRED_{EL}=MC₁[REF_{EL},MV_{EL}]+{UPS[REC_{BL}−MC₄[REF_{BL},MV_{EL}/2]]} (1.2)

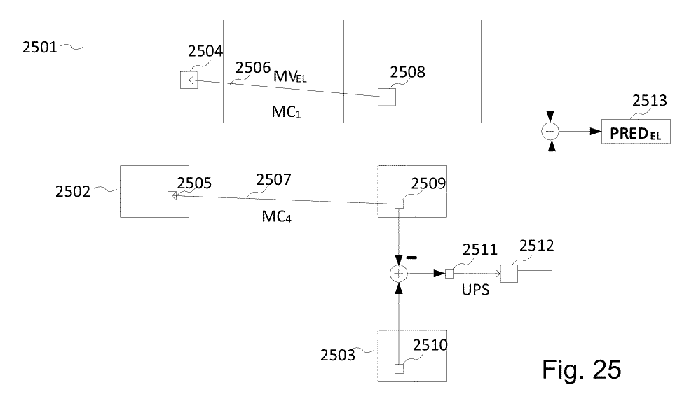

An example of this process is schematically illustrated in FIG. 25. The block 2508 (of size H×W) is obtained by motion compensation MC1 of a block 2504 (of size H×W) of the reference EL picture REFEL 2501 using the motion vector MVEL 2506. The block 2509 (of size h×w) is obtained by motion compensation MC4 of a block 2505 (of size h×w) of the reference BL picture REFBL 2502 using the downsampled motion vector MVEL 2507. This block 2509 is substracted to the BL block 2510 (of size h×w) of the BL current picture RECBL 2503, collocated with the current EL block, to generate the BL residual block 2511 (of size h×w). This BL residual block 2511 is then upsampled to obtain the upsampled residual block 2512 (of size H×W). The upsampled residual block 2512 is finally added to the motion compensated block 2508 to generate the prediction PREDEL 2513.

Another alternative for generating GRILP block predictor is to weight each part of the linear combination given in equation ((1.2). Consequently, the generic equation for GRILP is:

PRED_{EL}=λMC₁[REF_{EL},MV_{EL}]+α{UPS[REC_{BL}−βMC₄[REF_{BL},MV_{EL}/2]]} (1.3)

It should be noted that in addition to the upsampling and motion compensation processes mentioned above, some filtering operations may be applied to the intermediate generated blocks. For instance, a filtering operator FILTₓ (x taking several possible values for different filters) can be applied directly after the motion compensation, or directly after the upsampling or right after the second order residual prediction block generation. Some examples are provided in equations (1.4) to (1.9):

PRED_{EL}=MC₁[REF_{EL},MV_{EL}]+{UPS[REC_{BL}]−FILT₁(MC₂[UPS[REF_{BL}],MV_{EL}])} (1.4)

PRED_{EL}=UPS[REC_{BL}]+FILT₁(MC₃[REF_{EL}−UPS[REF_{BL}],MV_{EL}]) (1.5)

PRED_{EL}=MC₁[REF_{EL},MV_{EL}]+FILT₁({UPS[REC_{BL}−MC₄[REF_{BL},MV_{EL}/2]]}) (1.6)

PRED_{EL}=FILT₂(MC₁[REF_{EL},MV_{EL}])+{UPS[REC_{BL}]−FILT₁(MC₂[UPS[REF_{BL}],MV_{EL}])} (1.7)

PRED_{EL}=FILT₂(UPS[REC_{BL}])+FILT₁(MC₃[REF_{EL}−UPS[REF_{BL}],MV_{EL}]) (1.8)

PRED_{EL}=FILT₂(MC₁[REF_{EL},MV_{EL}])+FILT₁({UPS[REC_{BL}−MC₄[REF_{BL},MV_{EL}/2]]}) (1.9)

The different processes involved in the prediction process, such as, upsampling, motion compensation, and possibly filtering, are achieved using linear filters applied using convolution operators.

As mentioned above, the Base Mode prediction may use Second order Residual prediction. One way of implementing second order prediction in Base Mode involves using the GRILP mode to generate the base layer motion compensation residue (using the motion vector from the EL downsampled to the BL resolution). This option avoids the storage of the decoded BL residue, since the BL residue can be computed on the fly from the EL MV. In addition this computed residue is guaranteed to fit the EL residue since the same motion vector is used for the EL and BL block.

In a context of the invention, in addition to involving SAO filtering at the lower (base) layer level, SAO filtering is provided at the upper (enhancement) layer level when decoding a frame area of the upper layer, such as a LCU.

Above-mentioned contribution “Description of high efficiency scalable video coding technology proposal by Samsung and Vidyo” (Ken MacCann et al., JCTVC-K0044, 11^{th} Meeting: Shanghai, Conn., 10-19 Oct. 2012) already provides SAO filtering at the upper layer, in particular by SAO filtering the up-sampled decoded base layer used for Intra BL prediction.

According to the invention, all or part of the SAO parameters used for SAO filtering a processed frame area in a processed frame at the upper layer level are derived or inferred from the SAO parameters used at the lower layer, in particular from a co-located frame area in the temporally coinciding lower layer frame.

The goal of the derivation/inference of the SAO parameters is to improve the coding efficiency of the upper layer, since the corresponding SAO parameters are no longer transmitted for the upper layer. Therefore the rate cost of transmitting the SAO parameters in the bitstream 1204/1301 may be substantially decreased, with in addition a relative increase in visual quality due to SAO filtering.

Deliberately, no SAO filtering block has been shown in FIGS. 12 and 13. This is because the SAO filtering of a frame, or more generally of a frame area (e.g. LCU), according to the invention may be implemented at various locations (listed below) in the decoding loop of the encoder or decoder (i.e. to different frames in course of processing a current enhancement layer). In other words, various frames processed in the decoding loop may act as the “processed frame” introduced above, i.e. to which the SAO filtering with inferred parameters is applied.

In the locations listed below where the SAO filtering according to the invention would not be performed, a conventional SAO can optionally be implemented. In some embodiments, the conventional SAO filtering can be combined (e.g. one after the other) with the SAO filtering according to the invention, at the same location in the process.

The embodiments below can be combined (i.e. at several locations when processing the same frame) to provide several SAO filtering according to the invention in the same enhancement layer. However, to avoid substantial increase in complexity, the number of SAO filtering implemented in the process may be restricted (in one or several locations) during the processing of a current enhancement frame area. This is explained below with more details.

Some embodiments use enhancement frames, i.e. frames reconstructed from the enhancement layer bitstream, as “processed” frames, while other embodiments apply the SAO filtering on intermediary frames, i.e. on frames that are obtained or constructed because they are needed for decoding a current enhancement frame. This is for example the case of some frames used as reference frames for prediction. A majority of these intermediary frames as described below results from inter-layer prediction.

In one embodiment, the SAO filtering using SAO parameter prediction from the base layer is applied to the up-sampled decoded base layer (which then acts as the “processed frame”), in order to filter this base frame before it is used in the Inter-layer coding modes.

The filtered up-sampled base frame is used for example in the Intra BL coding mode but also in a Differential mode Inter layer (Diff mode) coding mode according to which the difference (or residual) between this up-sampled base frame and the original frame 101 is input to subpart A12 (instead of the original frame 101, thus requiring slight modifications in the Figures to offer coding/decoding of residuals only).

This embodiment corresponds to providing the SAO filtering in block 1208 of FIGS. 12 and 13, just before providing the up-sampled decoded base frame 1420 to the subpart A12/A13.

In another embodiment, the SAO filtering using SAO parameter prediction from the base layer is applied on the Diff mode frame as defined above, i.e. on the residual (or difference) input to subpart A12 in the Diff mode.

This particular case applies the SAO filtering according to the invention to residual pixel values and not to reconstructed pixel values, as in the other embodiments.

In another embodiment, the SAO filtering using SAO parameter prediction from the base layer is applied on the GRILP predictor. In this case the SAO filtering can be applied on frame area when GRILP 2414 is used to generate additional predictors or at frame level when is it used for the frame base mode;

In another embodiment, the SAO filtering using SAO parameter prediction from the base layer is applied on each term MC₁[REF_{EL}, MV_{EL}], UPS[REC_{BL}], MC₂[UPS[REF_{BL}], MV_{EL}] of GRILP equation1.1

In another embodiment, the SAO filtering using SAO parameter prediction form the base layer is applied on the frame area GRILP residual wich is obtained by using the term{UPS[REC_{BL}]−MC₂[UPS[REF_{BL}], MV_{EL}] of equation 1.1 UPS[REC_{BL}−βMC₄[REF_{BL}, MV_{EL}/2]]} of equation 1.3 or {UPS[REC_{BL}−MC₄[REF_{BL}, MV_{EL}/2]]} of equation 2.

In another embodiment, the SAO filtering using SAO parameter prediction form the base layer is applied on the difference between MC₁[REF_{EL}, MV_{EL}] and MC₂[UPS[REF_{BL}], MV_{EL}] of equation 1.1.

In yet another embodiment, the SAO filtering using SAO parameter prediction from the base layer is applied to the Base Mode prediction image 1440 (or to base mode blocks that are reconstructed if the full image 1440 is not reconstructed).

This embodiment corresponds to providing the SAO filtering just after deblocking 111′ in A12 and deblocking 206 in A13 for the Base Mode prediction, of FIGS. 12 and 13. As the deblocking is optional, the SAO filtering according to the invention may then be provided in replacement of these two blocks 111′ and 206 shown in the Figures.

In yet another embodiment, the SAO filtering using SAO parameter prediction from the base layer is applied to the encoded/decoded base frame at the base layer level. In particular this SAO filtering according to the invention is in addition to the SAO post-filtering already provided in the base layer. But the SAO filtering according to the invention is only used to generate a reconstructed base frame to be provided to the enhancement layer (e.g. in order to generate the Intra BL predictor or the Base Mode prediction frame or the Diff mode residual frame). In other words, the reconstructed base frame provided as an output of the base layer to the frame memory 108/204 (storing the reference base frames) does not undergo this SAO filtering according to the invention.

This embodiment offers complexity reduction for spatial scalability compared to when the SAO filtering according to the invention is applied on the upsampled reconstructed base frame.

In yet another embodiment, the SAO filtering using SAO parameter prediction from the base layer is applied to the reference frame pictures or blocks thereof stored in 104 or 208 of the enhancement layer modules A12, A13, just before they are used in motion estimation and compensation.

In yet another embodiment, the SAO filtering using SAO parameter prediction from the base layer is applied as a post-filtering to the reconstructed enhancement frames (i.e. to the encoded/decoded enhancement frame), just before they are stored in the frame memory 104 or 208 of the enhancement layer modules A12, A13.

This embodiment corresponds to providing the SAO filtering according to the invention just after (or in replacement of) deblocking 111 in A12 and deblocking 206 in A13 after adding (13D) the predictor with the reconstructed residual, of FIGS. 12 and 13. This is a symmetrical position to the SAO already providing at the base layer.

In any of these embodiments, the SAO filtering according to the invention can compete with a conventional SAO filtering.

In a first scenario, the SAO filtering according to the invention is systematically applied.

In a second scenario, a decision module may be configured to determine whether the conventional SAO filtering provides better coding efficiency of, e.g., the enhancement frame than a SAO filtering according to the invention, or not. According to the determination, decision is taken to apply the best SAO filtering to the considered enhancement frame, from amongst the conventional SAO filtering and the SAO filtering according to the invention.

This is decided at the encoder, and a corresponding flag (e.g. sao_merge_BL_flag) may be added to the bitstream at the frame level, or slice level. One flag sao_merge_BL_flag_Luma for Luma and one flag sao_merge_BL_flag_Chroma for Chroma can be used.

If this flag sao_merge_BL_flag_X is equal to 1, then the inter layer SAO parameters inheritance is activated. In that case when appropriate, the default SAO parameters are read in this slice header. Otherwise, the inter layer SAO parameters inheritance in not activated. In one embodiment, in that case, no SAO is applied to the concerned frame areas.

In a particular embodiment, the default parameters extracted from the bitstream is only the edge offset class sao_Default_EO_class_X. The other default parameters (the offset) are inferred.

This syntax should be considered for each frame or slice or predictor where the proposed SAO filtering is applied at frame or slide level.

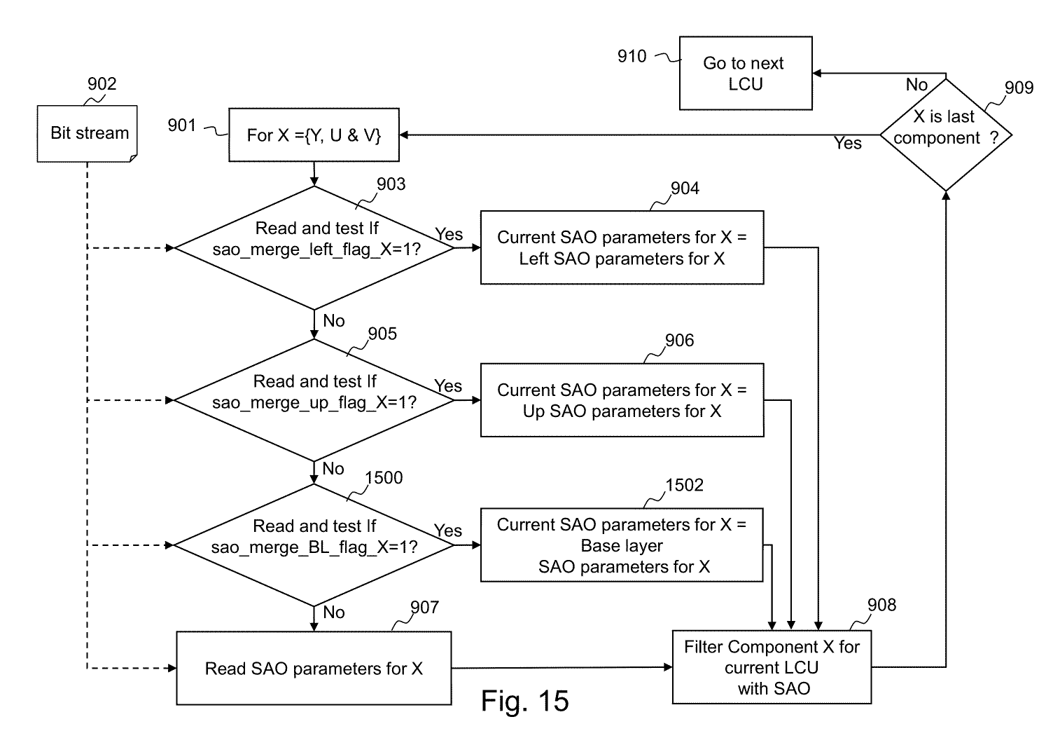

In a third scenario, the same decision is taken but at the LCU (or frame subarea) level. Obtaining the SAO parameters in this last scenario is illustrated by FIG. 15, which is based on FIG. 9.

Compared to FIG. 9, two steps have been added to process the above-defined sao_merge_BL_flag parameter: steps 1500 and 1502.

If the SAO parameters do not derive from the left LCU or above LCU (i.e. no at step 905), step 1500 consists in parsing the additional flag sao_merge_BL_flag from the bitstream 902 and to check if its value is true or “1”, meaning that the current SAO parameters (for color component X in case of sao_merge_BL_flag_X) derive from SAO parameters of the base layer according to the teachings of the invention.

In case of positive check, the SAO parameters of the base layer are retrieved and the SAO parameters for the enhancement layer are derived from these retrieved SAO parameters, as described below with more details.

In case of negative check, the process goes on at step 907, already described.

From the second and third scenario, it may easily be understood that the same decision of using the SAO parameter prediction according to the invention may be implemented at a number of various data levels, including the video sequence level, the frame type level, the frame level, the slice level, the tile level, the LCU level and the block level. An appropriate sao_merge_BL_flag is provided in the bitstream at each item of the level considered.

Contrary to competition between the SAO filtering according to the invention and a conventional SAO filtering, they can be combined in two successive SAO filtering rounds on the same frame in another embodiment. For example, a first pass of SAO filtering according to the invention is performed on a frame area, followed by a conventional SAO filtering.

As suggested above, the SAO filtering according to the invention may be combined with other SAO filtering according to the invention and/or with conventional SAO filtering, in one or several locations during the process of a current enhancement frame area.

To limit the complexity of the process, an embodiment of the invention may restrict the number of cascading SAO filtering to a maximum number, i.e. to a maximum number of SAO filtering during the process of the same a current enhancement frame area.

This maximum number may be set to 5, 6 or 7 to take advantage of the efficiency of cascading SAO filtering. However, to substantially improve decoding speed, the maximum number is preferably set to 2, meaning that at most two SAO filtering are implemented considering the various locations defined above when processing the same current enhancement frame area.

In a particular embodiment, this maximum number is set to 1. In this situation, if a SAO filtering according to the invention is applied to the Base Mode prediction image or to the up-sampled decoded base frame (Inter BL mode) or to the Diff Mode frame when loop-decoding an enhancement frame area, SAO-based post-filtering (or any other SAO filtering) is disabled for that decoded enhancement frame area.

The same consideration can be implemented at the frame level or slice level, meaning that a SAO filtering according to the invention is applied to such Base Mode prediction image (or up-sampled decoded base frame or Diff Mode frame), the SAO-based post-filtering (or any other SAO filtering) is disabled for the whole frame or slice. On the contrary, if no SAO filtering according to the invention is applied to the Base Mode prediction image (or up-sampled decoded base frame or Diff Mode frame), one SAO-based post-filtering (or any other SAO filtering) can be enabled for the whole frame or slice.

Decision on restricting the number of cascading SAO can be taken by the encoder itself, thus requiring signalling the same in the bitstream to the decoder.

In a variant, such restriction is predefined at the encoder and decoder. In this variant, SAO parameters can still be present in the bitstream for the LCUs even if the corresponding SAO filtering is not applied given the restriction. This makes it possible to keep the syntax unchanged for indicating the SAO filtering in the bitstream. In addition, using the prediction based on left and above LCU, this configuration makes it possible to still propagate the SAO parameters from LCU to LCU, thus avoiding repeating them in the bitstream (what would happen if a LCU would be set to “No SAO”, in which case the series of left/above LCU for prediction would be broken).

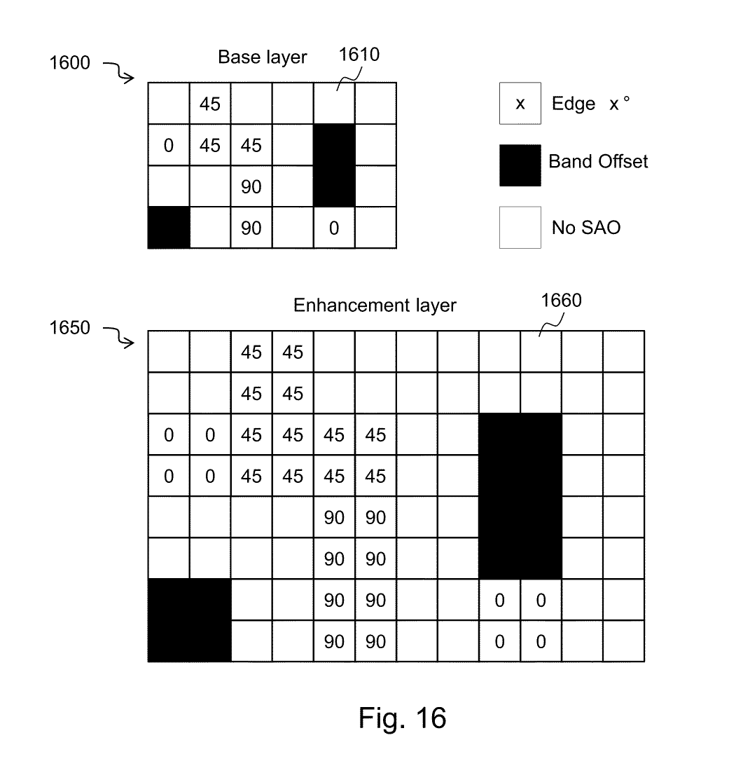

Several embodiments for derivation or inference of SAO parameters from the base layer to the enhancement layer are now described with reference to FIGS. 16 to 22. Preference is given to the SAO filtering of the enhancement frame itself in the examples below. One skilled in the art is skilled to apply the same teachings to any other frame (Base Mode prediction image, Diff mode residual, Base mode prediction image with GRILP motion compensation, GRILP frame area predictor, GRILP residual frame area residual, GRILP Base Mode residual frame or frame area,) that is processed in the decoding loop (at the encoder or decoder) of the enhancement layer.

In a first embodiment illustrated by FIG. 16, a direct derivation of the SAO parameters is implemented. In other words, the SAO parameters used for SAO filtering each frame area composing a processed frame (e.g. enhancement layer frame) are the same as the SAO parameters used for SAO filtering a corresponding co-located frame area in a lower layer frame (e.g. base layer) temporally coinciding with the upper layer frame area being processed. As exposed above, the words “frame area” cover a plurality of frame levels from the video sequence level to the block level.

Preferably it concerns LCUs. Also, while the lower layer is preferably a base layer, it may also be an enhancement layer in which case the upper layer is another enhancement layer.

The example of FIG. 16 illustrates a dyadic case, i.e. when the base layer and the enhancement layer present a spatial scalability having a ratio of 2.

A schematic partitioning of a base frame 1600 into 24 LCUs 1610 is shown where a SAO classification for each LCU is represented for each X components (one for X=Y_luma component; and one for X=UV_chroma components processed together).

Some of the LCUs don't contain SAO parameters because no SAO filtering is applied (sao_type_idx_X equals 0).

The other LCUs are classified in Edge 0° (sao_type_idx_X=2; sao_eo_class=0), 45° (sao_type_idx_X=2; sao_eo_class=1) or 90° (sao_type_idx_X=2; sao_eo_class=2) or 135° (sao_type_idx_X=2; sao_eo_class=3) or in Band offset (sao_type_idx_X=1).

The information about partitioning can be stored in a quad-tree structure in memory. The sao_band_position can be stored in the root of this quad-tree structure when the same band position is applied to all Band Offset classified LCUs, but can also be stored at each appropriate leaf of the quad-tree structure if a different sao_band_position is used at each LCU. In one embodiment applying to all embodiments of the invention, the SAO parameters are stored using objects of an object-oriented computer language. For example, a sao_type object may have several attributes including sao_type_idx, sao_type_class (used in Edge Offset), sao_type_position (used in Band Offset) and offsets.

Due to the spatial dyadic scalability, it is known that the enhancement frame 1650 in this example is made of 24*4=88 LCUs 1660.

In the embodiment of the direct derivation as shown in the Figure, the SAO partitioning defining the base frame 1600 is up-sampled according to the spatial ratio (i.e. 2) in order to match the LCU partitioning of the enhancement frame 1650. Then, due to the dyadic case, the SAO parameters (sao_type_idx; sao_eo_class; sao_band_position; offsets) of a LCU 1610 in the base frame 1600 are copied in four LCUs 1660 in the Enhancement layer 1650, more precisely in the four LCUs that are co-located to the LCU considered in the base frame, given the scalability ratio.

In case of another spatial scalability ratio, the same approach can be applied where the LCUs inherit SAO parameters from the co-located LCU in the base frame. When the scalability ratio leads to a LCU of the enhancement frame having several co-located LCUs in the base frame, criteria such as which LCU in the base frame provides the most of surface and/or which LCU in the base frame is the first LCU given a scanning order can be used to select the LCU from which the SAO parameters are derived.

Other scalability than spatial scalability may exist between the base layer and the enhancement layer. For example, in case of SNR scalability, the direct derivation may only consist in copying the SAO parameters LCU by LCU due to the same size of the base frame and the enhancement frame.

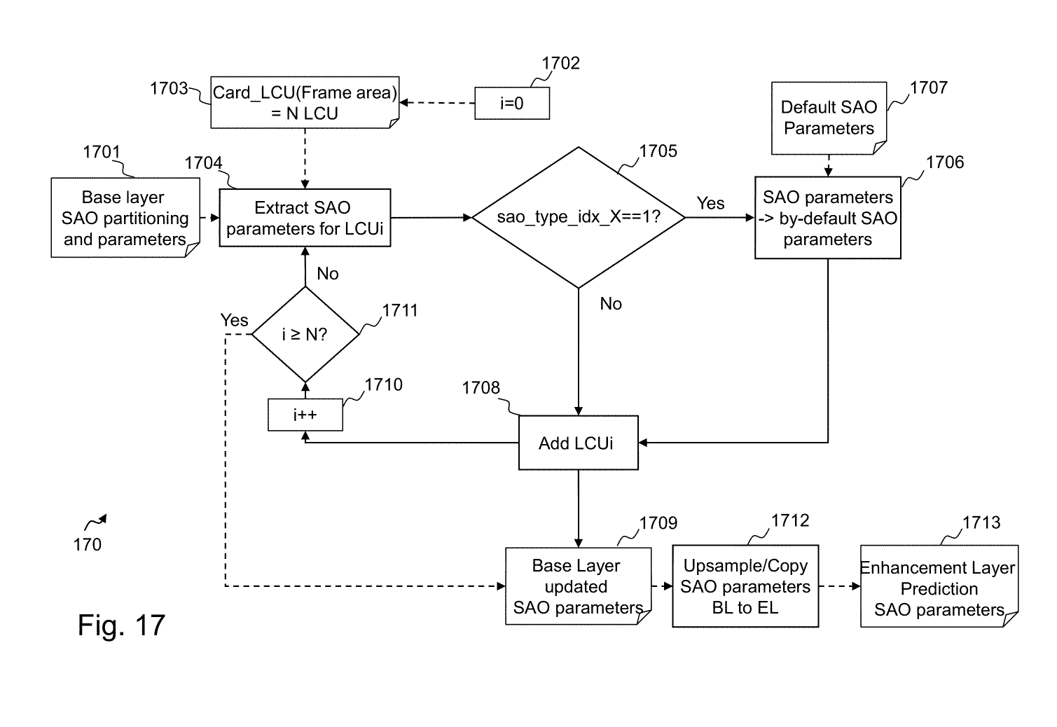

In a second embodiment illustrated below with reference to FIGS. 17 to 22, some SAO parameters of the base frame partitioning are modified before they are applied to the enhancement frame, in particular to co-located frame areas of the enhancement frame. Generally by-default parameters will be used, in replacement of all or part of the SAO parameters retrieved from the base layer.

In other words, the SAO parameters for SAO filtering a processed frame area (e.g. enhancement layer frame area) are first by-default SAO parameters when the SAO parameters applied to a co-located lower layer (base layer) frame area define a SAO filtering of a first type.

This is to avoid applying a SAO filtering of the base frame that may reveal not to be efficient at the enhancement layer (even sometimes it may deteriorate the enhancement frame quality).

FIG. 17 is a flow chart illustrating steps of a method for deriving SAO parameters from the base layer, involving modification of some SAO parameters according to a first example. It is implemented at the encoder and decoder.

In a first implementation of this example, the first type for which SAO parameters are modified is the Band Offset SAO filtering (sao_type_idx=1). On the contrary, the SAO parameters are kept unchanged for the LCUs which are classified as Edge Offset SAO type (sao_type_idx=2) and without SAO filtering (sao_type_idx=0).

This is because the Band Offset classification shifts the histogram band by band to match the original histogram as much as possible. Thus, even if the pixel value histogram of the enhancement frame is correlated to the pixel values histogram of the base frame, the shifts which have to be applied on the bands of the enhancement frame histogram are different from and not correlated to those of the base frame histogram.

On the contrary, the Edge Offset classification corrects particular artifacts related to the quantization in a certain direction. Generally the direction is correlated to LCU signal. This correlation exists in the same way in the enhancement frame and in the base frame. Thus the same artifact as in the base frame exists in the enhancement frame. This is why, in this context, the Edge Offset classification is preferably kept as SAO parameter from the base frame to the enhancement frame.

Of course, other embodiments may provide that the Band Offset classification at a base layer frame area is kept for the co-located enhancement layer frame area, while the Edge Offset classification is converted into another SAO filtering type, for example using the by-default SAO parameters. This variant makes it possible to define a different SAO filtering according to the invention, that may be cascaded to another SAO filtering according to the invention.

The SAO partitioning and parameters of the base frame 1701 are parsed in order to retrieve or extract SAO parameters for each LCUi 1704. The variable ‘i’ is set equal to 0 at the beginning of the process 1702 and will be incremented during the process in order to process each LCUi of the enhancement frame.

The type of SAO (parameter sao_type_idx_X) is read for the current LCUi and compared to “1” at step 1705.

If it is not equal to “1”, the SAO parameters are kept unchanged and stored, step 1708, in a quad-tree structure 1709 dedicated to store an updated SAO partitioning and parameters for the base frame. These parameters will not be sent in the bitstream since they can be obtained in a similar manner by the decoder (i.e. they can derive from the base layer).

If it is (output “yes” at step 1705), the corresponding (co-located) LCU in the base frame has been classified as Band Offset, in which case the retrieved SAO parameters are changed 1706, in particular are replaced by by-default SAO parameters 1707. The by-default SAO parameters are obtained (computed and selected) as described below. These parameters can be transmitted in the bitstream if the decoder cannot obtain them in a similar manner than at the encoder. Regardless to way to obtain such parameters, the decoder ultimately obtains these by-default SAO parameters.

The SAO parameters as obtained in step 1706 are then added at step 1708 to the quad-tree structure 1709 storing the updated SAO partitioning and parameters for the base frame.

Then the variable ‘i’ is incremented at step 1710 to process the next LCU (process back to 1704) until all the LCUs have been processed (test 1711 where the value of “i” becomes greater than or equal to the number N of LCUs in the base frame as determined in a previous step 1703).

When all the LCUs have been processed, the updated SAO partitioning and parameters for the base frame 1709 is up-sampled or copied at step 1712 as described above (in the dyadic case for example) in order to generate a SAO frame partitioning and parameter quad-tree to apply to the current frame to process 1713. This is the support to configure the SAO filter.

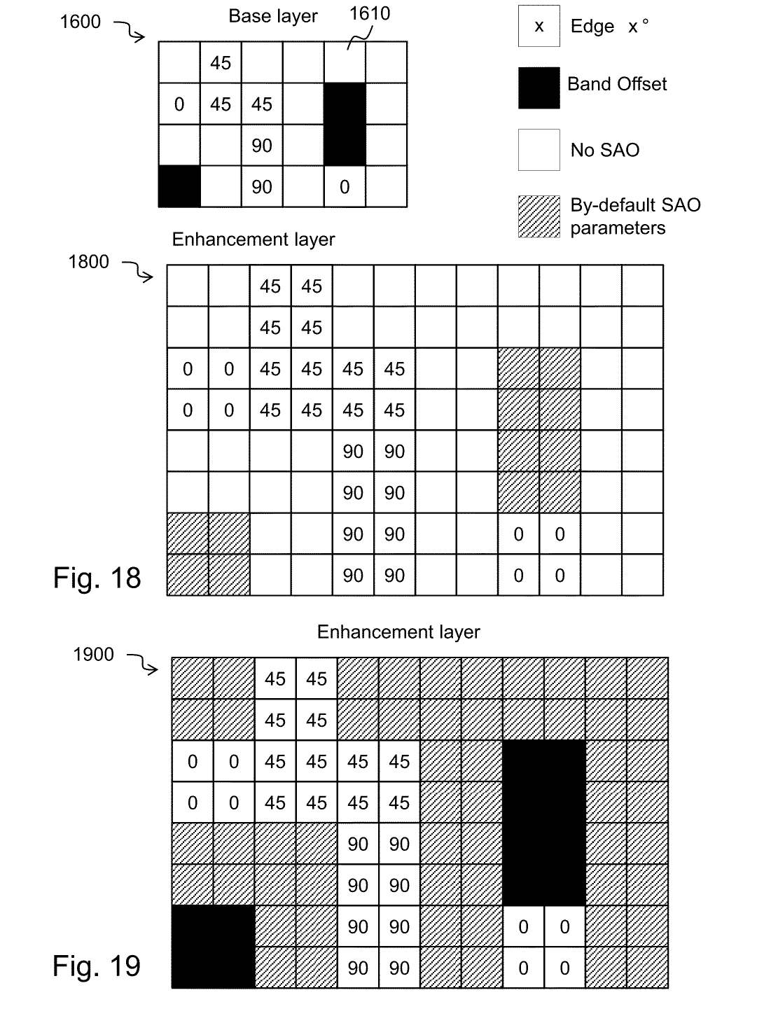

FIG. 18 illustrates the result of such process using the same base frame SAO partitioning as in FIG. 16.

As summarized by this Figure, the Band Offset class in the base frame 1600 is substituted with by-default SAO parameters in the corresponding LCU or LCUs of the enhancement frame 1800.

In a first particular embodiment, the by-default SAO parameters define no SAO filtering (sao_type_idx=0).

In a second particular embodiment, the by-default SAO parameters define an Edge Offset SAO filtering. Here, the LCUs with a Band Offset SAO type in the base frame are replaced by LCUs with an Edge Offset SAO type (as by-default parameters) for the enhancement layer. The SAO parameter is thus switched from sao_type_idx=1 to sao_type_idx=2. Below is described the selection of a direction of the by-default Edge Offset SAO filtering based on the pixel values.

This second particular embodiment (switch into Edge Offset) may be applied only to Luma component (X=Y) and not to Chroma components (X=UY), the latter being processed according to the above first particular embodiment for example.

In a second implementation of this first example of FIG. 17, the first type for which SAO parameters are modified is when no SAO has been applied (sao_type_idx=0). The SAO parameters are kept unchanged for the LCUs which are classified as Edge Offset SAO type (sao_type_idx=2) and Band Offset SAO type (sao_type_idx=1).

This requires the test condition of the decision module 1705 be changed by the condition “sao_type_idx_X==0?”.

This second implementation means that the SAO parameters for SAO filtering a processed frame area (e.g. enhancement layer frame area) are by-default SAO parameters when a co-located lower layer (e.g. base layer) frame area is not subject to SAO filtering.

The above second particular embodiment where the by-default SAO parameters define an Edge Offset SAO filtering is preferably implemented to handle the frame areas (e.g. LCUs) subject to SAO parameter modification, thus switching sao_type_idx=0 into sao_type_idx=2. Below is described the selection of a direction of the by-default Edge Offset SAO filtering based on the pixel values.

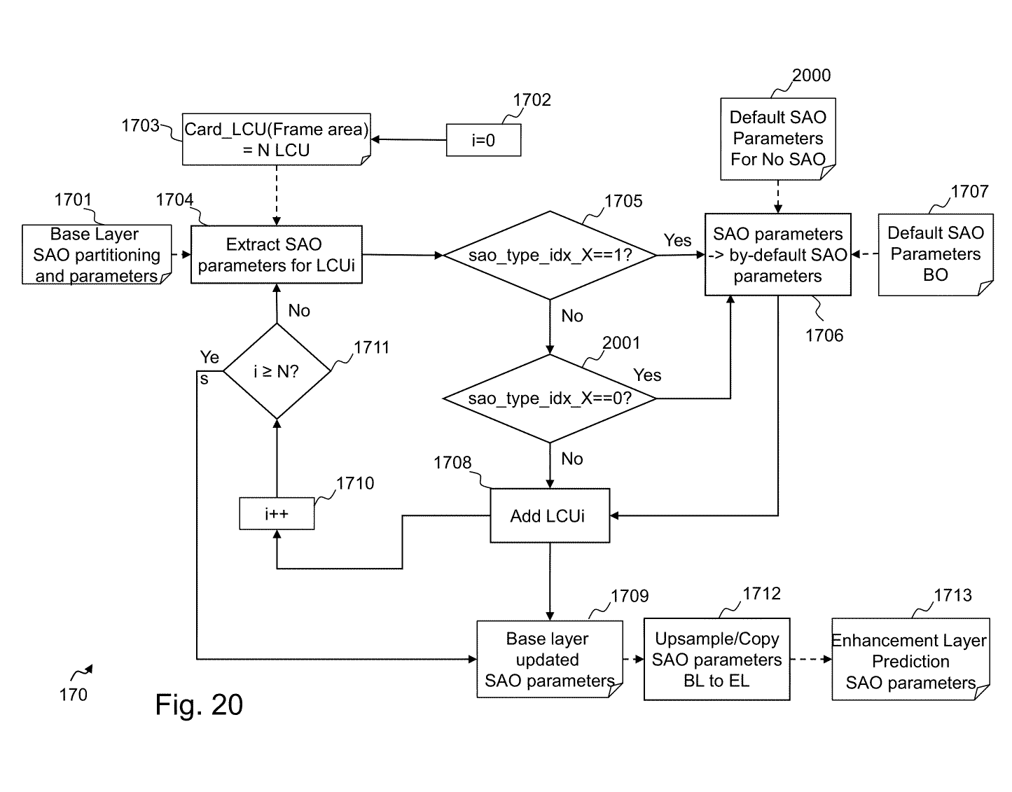

The two implementations above can be combined together, meaning that the LCUs having the Band Offset SAO type and the No SAO type at the base frame are changed into LCUs having the by-default SAO parameters at the enhancement layer level. This is illustrated through FIG. 20 where two additional blocks are provided: namely block 2000 providing a second set of by-default SAO parameters (the first set being 1707) and block 2001 which adds the test condition “sao_type_idx_X==0?” (used in the second implementation above) to the test condition “sao_type_idx_X==1?” already defined at the decision module 1705.

In this combinatory implementation, the base frame LCUs having a Band Offset SAO type (test 1705) are changed into LCUs having first by-default SAO parameters 1707 for use at the enhancement layer level. Also the base frame LCUs having a No SAO type parameter (test 2001) are changed into LCUs having second by-default SAO parameters 2000 for use at the enhancement layer level.

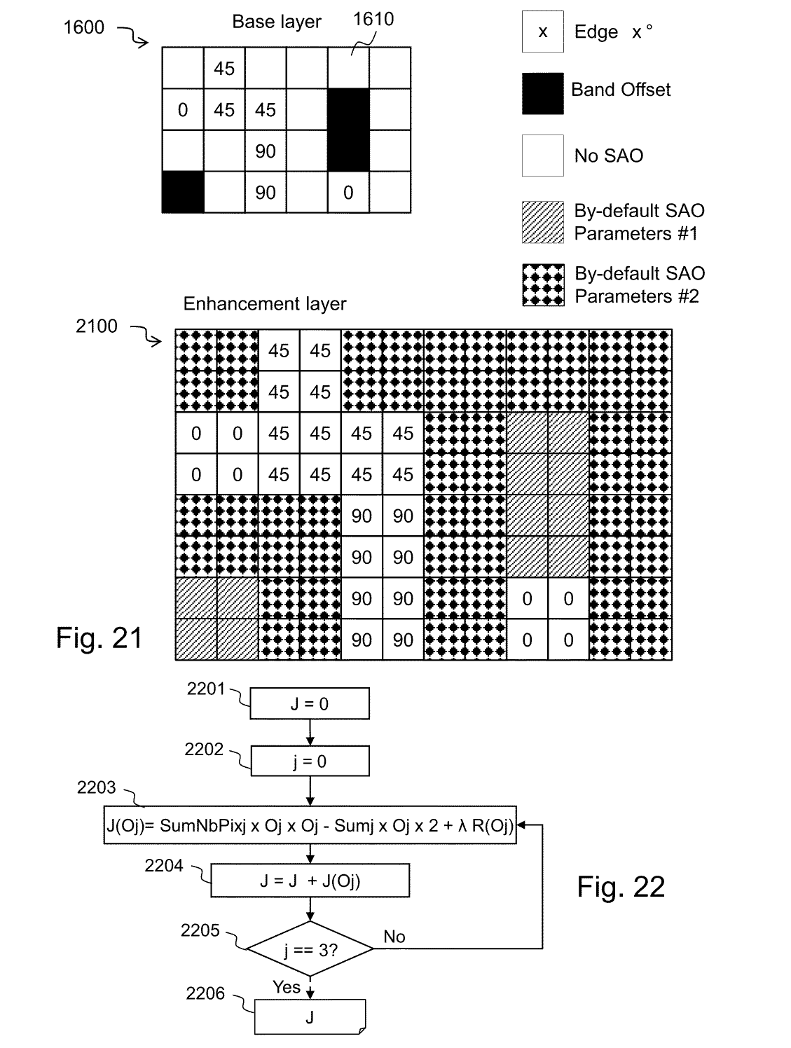

FIG. 21 illustrates the result of such process using the same base frame SAO partitioning as in FIG. 16.

In these various embodiments, the SAO parameters which can be fully derived from the base layer are not transmitted in the bitstream. In addition, rules driving the switching between SAO filtering types can be predefined at both the encoder and decoder. Therefore a limited number of SAO parameters (by-default parameters) is transmitted in the bitstream (in some embodiments, it may even be that no by-default SAO parameters are transmitted).

Several embodiments for the by-default parameters can be envisaged. The computation of the by-default parameters will be described below.

The first by-default SAO parameters may be no SAO (sao_type_idx=0) or Edge Offset SAO parameters (sao_type_idx=2) as briefly introduced above. The second by-default SAO parameters may be Edge Offset SAO parameters (sao_type_idx=2) as also described above. The first and second by-default SAO parameters may be the same.

Where the Edge Offset SAO parameters are used as by-default SAO parameters, it may be only for the Luma component (X=Y), the Chroma components (X=UV) using by-default SAO parameters of another type, for example Band Offset SAO parameters if the former SAO type in the base frame is not Band Offset, or No SAO parameters if the former SAO type in the base frame is not No SAO.

Based on the above explanation, it is easy to note that the same process can be performed at the encoder and at the decoder. If the encoder and decoder are configured to implement the same scheme for modification of the SAO parameters between the base frame and the enhancement frame, no specific information needs to be sent in the bitstream. However, if several schemes are available at the encoder and decoder, the encoder may indicate in the bitstream which scheme has been used (e.g. at the frame level or at the video sequence level) in order to ensure synchronization between the two devices.

Another embodiment, still involving modification of SAO parameters inferred from the base frame, may modify part of the SAO parameters, excluding the SAO filtering type (sao_type_idx remains unchanged as retrieved from the co-located base frame area). This may for example involve changing SAO offsets into by-default offsets, while keeping the remainder of the SAO parameters unchanged.

This modification may affect all or part of the LCUs. For example only the LCUs co-located with specific LCUs in the base frame are affected, the specific LCUs in the base frame being for example those having a particular SAO filtering type (e.g. sao_type_idx=0 or sao_type_idx=1 or sao_type_idx=2).

While the by-default offsets can be predefined offsets, such as {1, 0, 0, −1}, they may pre-calculated as described below in a variant.

Another embodiment, still involving modification of SAO parameters inferred from the base frame, may consider reevaluating the Edge Offset direction in case the co-located LCU in the base frame has an Edge Offset SAO type or the Band Offset first class.

From these several examples, one may understand that any of the SAO parameters can be modified using appropriate predefined or pre-calculated SAO parameters.

The selection of the by-default SAO parameters is now described using several examples. This selection can be implemented in the same way at the encoder and at the decoder in order to ensure synchronization therebetween. However, some examples require the encoder to perform the computation of the SAO parameters using for example the original frame, in which case the SAO parameters are then transmitted in the bitstream as additional information.

In a first example of by-default SAO parameter selection, all the SAO parameters (including sao_type_idx; sao_eo_class; sao_band_position; offsets) are computed from scratch for the LCUs to which by-default parameters have to be applied. They are referred below to “by-default LCUs”.

According to various scalability levels, new by-default SAO parameters can be computed at each new slice, at each new frame, for each frame type, at each new video sequence, etc.

In some embodiments, several types of by-default LCUs may coexist: in an example above, the LCUs of the enhancement frame co-located with base frame LCUs having No SAO coexist with LCUs co-located with base frame LCUs having a Band Offset SAO type. In this situation, the process described below can be applied independently to the several types of by-default LCUs (in which case several sets of by-default SAO parameters are obtained—see blocks 1707 and 2000 in FIG. 20) or can apply for all the LCUs as a whole in case the same by-default SAO parameters are used for all the several types.

To achieve this, the predefined SAO parameters are determined from all the by-default LCUs considered within the processed frame (e.g. enhancement layer frame).

Considering now a type of by-default LCUs, corresponding by-default SAO parameters are computed and selected based on a rate distortion criterion using the same mechanisms as those described above with reference to FIGS. 5, 6 and 7 in one embodiment. However, the process of FIG. 5 should be modified at step 503 to consider all the by-default LCUs of the SAO filtering type considered instead of only one LCU. Indeed the same by-default SAO parameters are computed for a set of by-default LCUs and not for a single LCU of the enhancement layer.

The rate distortion criterion can be applied for the four Edge Offset directions and, possibly, for the Band Offset classification (if implemented as a by-default possibility). Then using the process of FIGS. 6 and 7, the rate distortion cost for all the possible SAO filtering is determined, and their respective four offset values. The best SAO filtering is then selected for the by-default LCUs.

As this embodiment requires using the original frame to compute the rate distortion cost at the encoder, the selected by-default parameters need to be transmitted and indicated in the bitstream at the appropriate level (at each slice in the slice header, at each frame in the frame header, for each frame type, at each video sequence, etc.).

In a close-related embodiment, LCUs of the frame considered other than the by-default LCUs (i.e. those having new SAO parameters, including new SAO filtering type, compared to the corresponding SAO parameters of the base layer) may also have part of the inferred SAO parameters that are modified.

In the above example, the by-default LCUs are those co-located with base frame LCUs having no SAO or Band Offset SAO filtering. The other LCUs are thus those co-located with base frame LCUs having Edge Offset SAO filtering.

In that case, it may be provided that the offsets for those “other LCUs” are computed again (the Edge Offset SAO type is kept), independently to the by-default SAO parameters, using a rate distortion criterion based on all the “other LCUs” having the same SAO filtering class (sao_eo_class) and belonging to the level considered (slice, frame, frame type or sequence level). By using the process of FIGS. 5 and 6 (with modified step 503), a set of four new offsets is computed for each of the four Edge Offset directions for the level considered. It results that four sets of four new offsets are transmitted for these four directions, together with one or several sets of four by-default offsets and possibly a set of new offsets for the Band Offset SAO filtering (which however may be specified at another level, for example at each LCU). In case some of these offsets can be determined in the same way by the decoder, they are not necessarily transmitted in the bitstream.

This embodiment can be useful when the quality difference between the base layer and the enhancement layer is high.

Recomputing the offsets for the LCUs having the same SAO filtering class in the base frame can also be implemented independently to the above by-default approach where all the SAO parameters are new. Indeed, such situation corresponds to only calculating new offsets for the Edge Offset classified LCUs using the pixel values of those LCUs having the same class.

In a second example of by-default SAO parameter selection, the Edge Offset direction only is determined, while the by-default offsets are predetermined used one of the methods described below that can be implemented at both the encoder and the decoder.

The offsets being known in advance, the process of FIG. 6 can be simplified as shown in FIG. 22 in order to compute a rate distortion cost for each the four Edge Offset directions and to select the by-default Edge Offset direction having the best rate distortion cost.

More specifically, FIG. 22 shows how to compute the rate distortion cost J for a given Edge Offset direction, given the four predefined offsets Oⱼ (j=0 to 3) for that direction.

SumNbPixj is computed as in FIG. 5 but where step 503 considers all the by-default LCUs for which the same Edge Offset direction is to be computed. The loop makes it possible to sum the rate distortion costs for each offset Oⱼ using the table of FIG. 3b.

Since the original frame is used to compute the rate distortion cost at the encoder, the best Edge Offset direction (with the best, i.e. lowest, J) is indicated in the bitstream at the appropriate slice/frame/sequence level.

The selection of offsets for the by-default SAO parameters is now described.

In the examples below, it is assumed that the offsets are predetermined in a similar manner at the encoder and at the decoder, which means that they are not explicitly transmitted in the bitstream. In particular, the same rule as used in HEVC and specifying that O1>=0, O2>=0, O3<=, O4<=0, is implemented.

According to a first example, the by-default set of offsets depends on the QP (quantization parameter) value used by the dequantizer 108′ or 1306 of the enhancement layer for the LCU being currently decoded. For example the absolute values of the offsets O1 and O4 are set equal to 1 or 0 if the QP is low (i.e. below a threshold value) and set to 2 if the QP is high (above the threshold value). O2 and O3 are set to 0.

In the same way, the absolute offset value can depend on the QP difference between the base layer and the enhancement layer, i.e. the difference of QP value used between 108′ of A12 and 108′ of B12 or between 1306 of A13 and 203 of B13.

In another embodiment, the offset values can depend on the location in the processing at which the SAO filtering according to the invention is applied. This is because frame quality can substantially differ when considering two different frames. For example, the base layer has usually a better video quality than the Intra-BL frame. In this context, different offset values will be used for different frames (Base mode prediction image, Intra BL frame, post filtering on reconstructed enhancement frame, Diff mode image, etc.).

In another embodiment, the offset values can depend on the bit depth of the pixel values forming the enhancement frame area considered. Usually, the pixel values are coded onto 8 bits. When 10-bit values are used, the offsets computed for 8-bit values are multiplied by 4. Similarly, the offsets computed for 8-bit values are multiplied by 16 when applied to 12-bit pixel values.

In yet another embodiment, the absolute offset values of categories 2 and 3 (i.e. O2 and O3) are set equal to 0.

In yet another embodiment, the absolute offset values of categories 2 and 3 (i.e. O2 and O3) are less or equal to respectively the absolute offset value of category 1 and of category 4 (i.e. O1 and O4).

In yet another preferred embodiment, if the offsets are predetermined, the SAO filtering type assigned to the LCU's of the frame considered receiving those predetermined offsets is set to the Edge Offset SAO filtering type with the same Edge Offset direction.

Of course, these embodiments can be combined one with each other.

In one embodiment, a prefixed by-default set of offsets, for example 1, 0, 0, −1, is used to replace any offsets retrieved from the base frame. This may be true for all the LCUs of the frame considered that thus inherit of the SAO filtering type and class from the base frame but implement the prefixed offsets. In a variant, only the LCUs having a given SAO filtering type and optionally a given SAO class have their offsets replaced by the prefixed by-default offsets.

As it derives from the above explanation, the SAO parameters inference according to the invention makes it possible to replace non efficient inferred SAO parameters by by-default SAO parameters. For example, where the SAO parameters derive from the base layer, only the Edge Offset SAO parameters are kept and applied as such at the enhancement layer, while the other SAO parameters are substituted with appropriate by-default SAO parameters.

In one embodiment of the invention aiming at reducing the complexity of the SAO filtering at the decoder, the SAO filtering is applied to a frame area of a frame considered independently of neighbouring frame areas in the same frame.

Indeed, at the decoder, generating a full frame predictor, as in the Intra BL coding mode or the Diff mode or the Base Mode coding mode, is very costly in term of memory and computational time. In particular, it is not cost-effective when LCUs or frame areas of the frame predictor are not often selected.

The neighbouring LCUs are for example used when applying the Edge Offset SAO filtering since the pixels at the edge of the current LCU needs to be compared to a neighbouring pixel that may belong to a neighbouring LCU, depending on the direction considered. But motion compensations, which are very costly, may be required to obtain those neighbouring LCUs.

To face this situation, this embodiment provides that the SAO filtering be performed without using pixels of neighbouring frame areas (e.g. blocks or LCUs), meaning that the SAO filtering is applied independently, frame area by frame area. The SAO filtering only uses the pixels of the frame area considered.

The pixels which require missing neighbouring pixels in order for the former to be SAO-filtered, may be discarded from filtering. In a variant, the missing pixels can be replaced by padding pixels, for example by copying the frame edge pixels.

This approach of avoiding processing each frame area independently of the other may be performed to the reconstructed blocks or LCUs of the reconstructed up-scaled base layer, of the reconstructed Diff mode residual frame, and of the Base Mode prediction image.

It may also be applied to the predictor blocks used from these several frames. Indeed, the partitioning of these frames when being reconstructed from the base layer is similar to the partitioning of the base frame. But the partitioning of the same frames used as predictor at the enhancement layer may significantly differ from the partitioning of the base frame, since partitioning criteria are specific to the enhancement layer.

Due to this approach by independent frame area (e.g. LCU), the SAO filtering can be directly applied on the predictor. Therefore, for reference frames, the SAO filtering can be applied on the fly frame area by frame area, and not on the whole reference frame.

It can be shown that applying a classical SAO to enhancement layer images at a frame area or frame level provides generally the best compression results. Indeed in that case SAO parameters are obtained with a rate distortion selection process better considering the image content. However in some case, the difference between a frame area SAO filtered with a classical SAO and a same frame area filtered with SAO parameters inherited from the base layer will be low even though the complexity reduction thanks to the use of SAO parameters inherited from the base layer will be important.

In one embodiment It is proposed to apply the SAO using inter layer prediction of SAO parameters only to a sub-part of the frame areas contained in a enhancement layer frame. Remaining frame areas will be SAO filtered using the classical SAO. The selection of which SAO applying to a frame area could be based on the coding mode of this frame area. For instance coding modes inducing a direct up-sampling of base layer data will inherit their SAO parameters from the base layer. These modes comprises the intra BL mode. Other modes (base mode, GRILP, base mode with GRILP motion compensation, inter diff, . . . ) will use the classical SAO without inheriting the SAO parameters from the base layer. In the case of the GRILP, inter Diff, and the base mode when it uses inter layer residual prediction, the residual predictor will be filtered by the classical SAO.

In that case sao_merge_BL_flag_X equal to 1, indicates that the inheritance of SAO parameters is activated only for frame areas encoded in a mode for which inheritance of the SAO parameters from the base layer is possible (for instance the intra BL mode).

All these embodiments can be combined.

The above examples are merely embodiments of the invention, which is not limited thereby.

1. A method of encoding or decoding a scalable video sequence made of at least one lower layer and one upper layer, the method comprising:
decoding a lower layer bitstream to obtain first sample adaptive offset, SAO, parameters defining a first SAO filtering applied to at least one lower layer frame area; and
decoding an upper layer bitstream into at least one decoded upper layer frame area, using a second SAO filtering applied to at least one processed frame area of a processed frame based on respective second SAO parameters;
wherein part or all of the second SAO parameters are inferred from the first SAO parameters.

2. The method of claim 1, wherein the second SAO parameters for SAO filtering a first processed frame area in the processed frame are first by-default SAO parameters when the first SAO parameters applied to a co-located lower layer frame area in a lower layer frame define a SAO filtering of a first type.

3. The method of claim 2, wherein the first type of SAO filtering is a Band Offset SAO filtering.

4. The method of claim 2, wherein a second processed frame area in the processed frame is assigned with a SAO filter type taken from the first SAO parameters applied to a co-located lower layer frame area in the lower layer frame, when the SAO filter type of the first SAO parameters is an Edge Offset SAO filtering.

5. The method of claim 2, wherein the first by-default SAO parameters define no SAO filtering for the first processed frame area.

6. The method of claim 1, wherein the second SAO parameters for SAO filtering a first processed frame area in the processed frame are second by-default SAO parameters when a co-located lower layer frame area in a lower layer frame is not subjected to SAO filtering.

7. The method of claim 2, wherein the first or second by-default SAO parameters define an Edge Offset SAO filtering.

8. The method of claim 6, wherein the first or second by-default SAO parameters define an Edge Offset SAO filtering.

9. The method of claim 7, wherein the processed frame comprises at least one luminance component and one chrominance component, and the first or second by-default SAO parameters define the Edge Offset SAO filtering of the luminance component only and not of the chrominance component.

10. The method of claim 9, wherein the first or second by-default SAO parameters for the first processed frame area in the chrominance component define a Band Offset SAO filtering.

11. The method of claim 8, wherein the processed frame comprises at least one luminance component and one chrominance component, and the first or second by-default SAO parameters define the Edge Offset SAO filtering of the luminance component only and not of the chrominance component.

12. The method of claim 11, wherein the first or second by-default SAO parameters for the first processed frame area in the chrominance component define a Band Offset SAO filtering.

13. The method of claim 2, wherein the first by-default SAO parameters define no SAO filtering and the second by-default SAO parameters define an Edge Offset SAO filtering.

14. The method of claim 2, wherein the first and second by-default SAO parameters are the same.

15. The method of claim 2, further comprising determining all or part of the first or second by-default SAO parameters from all the processed frame areas in a frame part of the processed frame that are subjected to SAO filtering using such first or second by-default SAO parameters.

16. The method of claim 6, wherein the first by-default SAO parameters define no SAO filtering and the second by-default SAO parameters define an Edge Offset SAO filtering.

17. The method of claim 6, wherein the first and second by-default SAO parameters are the same.

18. The method of claim 6, further comprising determining all or part of the first or second by-default SAO parameters from all the processed frame areas in a frame part of the processed frame that are subjected to SAO filtering using such first or second by-default SAO parameters.

19. The method of claim 15, further comprising including the determined first or second by-default SAO parameters within the upper layer bitstream.

20. The method of claim 15, wherein the first or second by-default SAO parameters includes predefined offsets and a predefined SAO filter type defining an Edge Offset SAO filtering, and determining all or part of the first or second by-default SAO parameters comprises determining an Edge Offset direction based on a rate distortion criterion using the predefined offsets and samples of all the processed frame areas in the frame part of the processed frame that are subjected to SAO filtering using the first or second by-default SAO parameters.

21. The method of claim 18, further comprising including the determined first or second by-default SAO parameters within the upper layer bitstream.

22. The method of claim 18, wherein the first or second by-default SAO parameters includes predefined offsets and a predefined SAO filter type defining an Edge Offset SAO filtering, and determining all or part of the first or second by-default SAO parameters comprises determining an Edge Offset direction based on a rate distortion criterion using the predefined offsets and samples of all the processed frame areas in the frame part of the processed frame that are subjected to SAO filtering using the first or second by-default SAO parameters.

23. The method of claim 2, wherein offsets of the first or second by-default SAO parameters depend on a quantization parameter implemented in the decoding of the upper layer bitstream.

24. The method of claim 6, wherein offsets of the first or second by-default SAO parameters depend on a quantization parameter implemented in the decoding of the upper layer bitstream.

25. The method of claim 1, wherein the second SAO parameters used for SAO filtering each processed frame area composing the processed frame are the same as the first SAO parameters used for SAO filtering a corresponding co-located lower layer frame area in a lower layer frame temporally coinciding with the at least one upper layer frame area being decoded.

26. The method of claim 1, wherein inferring the second SAO parameters includes replacing SAO offsets of the first SAO parameters by determined offsets, and keeping a SAO filter type and, if any, a filter-type-depending sub-parameter of the first SAO parameters, to obtain the second SAO parameters.

27. The method of claim 26, wherein replacing SAO offsets of the first SAO parameters by determined offsets comprises determining the offsets from all the processed frame areas within a frame part of the processed frame that inherit the same SAO filter type and the same filter-type-depending sub-parameter from first SAO parameters of a lower layer frame.

28. The method of claim 26, wherein the determined offsets comprise the same predefined set of SAO offsets dedicated for all the processed frame areas within a frame part of the processed frame.

29. The method of claim 28, wherein the predefined set of offsets equals the four following offsets {1, 0, 0, −1}.

30. The method of claim 1, wherein the second SAO filtering is applied to the first processed frame area independently of neighbouring frame areas in the same processed frame.

31. The method of claim 1, wherein decoding an upper layer bitstream comprises performing a restricted number of SAO filtering on the same processed frame area, including the second SAO filtering based on the second SAO parameters.

32. The method of claim 1, wherein the processed frame includes an upper layer frame reconstructed from the upper layer bitstream during the decoding.

33. The method of claim 1, wherein the processed frame includes an intermediary frame obtained independently of the upper layer bitstream and used to decode the upper layer frame area.

34. The method of claim 33, wherein the intermediary frame is constructed using a lower layer frame that temporally coincides with the at least one upper layer frame area being decoded.

35. The method of claim 34, wherein the intermediary frame is used as a spatial or temporal predictor for the upper layer frame area being decoded.

36. The method of claim 34, wherein the intermediary frame includes an up-sampled version of a decoded lower layer frame.

37. The method of claim 34, wherein the intermediary frame mixes frame areas extracted from a decoded lower layer frame and frame areas extracted from reference frames of the upper layer using prediction information from the lower layer.

38. The method according to claim 36 wherein the up-sampling operation allowing obtaining the up-sampled version the decoded lower layer frame is applied on a version of the decoded lower layer frame on which had been applied a SAO filtering using the second SAO parameters.

39. A device for encoding or decoding a scalable video sequence made of at least one lower layer and one upper layer, the device comprising:
an internal base decoder configured to decode a lower layer bitstream to obtain first sample adaptive offset, SAO, parameters defining a first SAO filtering applied to at least one lower layer frame area; and
an internal enhancement decoder configured to decode an upper layer bitstream into at least one decoded upper layer frame area, using a second SAO filtering applied to at least one processed frame area of a processed frame based on respective second SAO parameters;
wherein part or all of the second SAO parameters are inferred from the first SAO parameters.

40. The device of claim 39, wherein the second SAO parameters for SAO filtering a first processed frame area in the processed frame are first by-default SAO parameters when the first SAO parameters applied to a co-located lower layer frame area in a lower layer frame define a SAO filtering of a first type.

41. The device of claim 40, wherein the first type of SAO filtering is a Band Offset SAO filtering.

42. The device of claim 40, wherein a second processed frame area in the processed frame is assigned with a SAO filter type taken from the first SAO parameters applied to a co-located lower layer frame area in the lower layer frame, when the SAO filter type of the first SAO parameters is an Edge Offset SAO filtering.

43. The device of claim 40, wherein the first by-default SAO parameters define no SAO filtering for the first processed frame area.

44. The device of claim 39, wherein the second SAO parameters for SAO filtering a first processed frame area in the processed frame are second by-default SAO parameters when a co-located lower layer frame area in a lower layer frame is not subjected to SAO filtering.

45. The device of claim 40, wherein the first or second by-default SAO parameters define an Edge Offset SAO filtering.

46. The device of claim 44, wherein the first or second by-default SAO parameters define an Edge Offset SAO filtering.

47. The device of claim 45, wherein the processed frame comprises at least one luminance component and one chrominance component, and the first or second by-default SAO parameters define the Edge Offset SAO filtering of the luminance component only and not of the chrominance component.

48. The device of claim 47, wherein the first or second by-default SAO parameters for the first processed frame area in the chrominance component define a Band Offset SAO filtering.

49. The device of claim 46, wherein the processed frame comprises at least one luminance component and one chrominance component, and the first or second by-default SAO parameters define the Edge Offset SAO filtering of the luminance component only and not of the chrominance component.

50. The device of claim 49, wherein the first or second by-default SAO parameters for the first processed frame area in the chrominance component define a Band Offset SAO filtering.

51. The device of claim 40, wherein the first by-default SAO parameters define no SAO filtering and the second by-default SAO parameters define an Edge Offset SAO filtering.

52. The device of claim 40, wherein the first and second by-default SAO parameters are the same.

53. The device of claim 40, further comprising a SAO parameter determining module configured to determine all or part of the first or second by-default SAO parameters from all the processed frame areas in a frame part of the processed frame that are subjected to SAO filtering using such first or second by-default SAO parameters.

54. The device of claim 44, wherein the first by-default SAO parameters define no SAO filtering and the second by-default SAO parameters define an Edge Offset SAO filtering.

55. The device of claim 44, wherein the first and second by-default SAO parameters are the same.

56. The device of claim 44, further comprising a SAO parameter determining module configured to determine all or part of the first or second by-default SAO parameters from all the processed frame areas in a frame part of the processed frame that are subjected to SAO filtering using such first or second by-default SAO parameters.

57. The device of claim 53, configured to include the determined first or second by-default SAO parameters within the upper layer bitstream.

58. The device of claim 53, wherein the first or second by-default SAO parameters includes predefined offsets and a predefined SAO filter type defining an Edge Offset SAO filtering, and the SAO parameter determining module is configured to determine an Edge Offset direction based on a rate distortion criterion using the predefined offsets and samples of all the processed frame areas in the frame part of the processed frame that are subjected to SAO filtering using the first or second by-default SAO parameters.

59. The device of claim 56, configured to include the determined first or second by-default SAO parameters within the upper layer bitstream.

60. The device of claim 56, wherein the first or second by-default SAO parameters includes predefined offsets and a predefined SAO filter type defining an Edge Offset SAO filtering, and the SAO parameter determining module is configured to determine an Edge Offset direction based on a rate distortion criterion using the predefined offsets and samples of all the processed frame areas in the frame part of the processed frame that are subjected to SAO filtering using the first or second by-default SAO parameters.

61. The device of claim 40, wherein offsets of the first or second by-default SAO parameters depend on a quantization parameter implemented in the decoding of the upper layer bitstream.

62. The device of claim 44, wherein offsets of the first or second by-default SAO parameters depend on a quantization parameter implemented in the decoding of the upper layer bitstream.

63. The device of claim 39, wherein the second SAO parameters used for SAO filtering each processed frame area composing the processed frame are the same as the first SAO parameters used for SAO filtering a corresponding co-located lower layer frame area in a lower layer frame temporally coinciding with the at least one upper layer frame area being decoded.

64. The device of claim 39, configured to infer the second SAO parameters by replacing SAO offsets of the first SAO parameters by determined offsets, and keeping a SAO filter type and, if any, a filter-type-depending sub-parameter of the first SAO parameters, to obtain the second SAO parameters.

65. The device of claim 64, configured to replace SAO offsets of the first SAO parameters with determined offsets by determining the offsets from all the processed frame areas within a frame part of the processed frame that inherit the same SAO filter type and the same filter-type-depending sub-parameter from first SAO parameters of a lower layer frame.

66. The device of claim 64, wherein the determined offsets comprise the same predefined set of SAO offsets dedicated for all the processed frame areas within a frame part of the processed frame.

67. The device of claim 66, wherein the predefined set of offsets equals the four following offsets {1, 0, 0, −1}.

68. The device of claim 39, wherein the internal enhancement decoder is configured to apply the second SAO filtering to the first processed frame area independently of neighbouring frame areas in the same processed frame.

69. The device of claim 39, wherein the internal enhancement decoder comprises a restricted number of SAO filtering on the same processed frame area, including the second SAO filtering based on the second SAO parameters.

70. The device of claim 39, wherein the processed frame includes an upper layer frame reconstructed from the upper layer bitstream during the decoding.

71. The device of claim 39, wherein the processed frame includes an intermediary frame obtained independently of the upper layer bitstream and used to decode the upper layer frame area.

72. The device of claim 71, wherein the intermediary frame is constructed using a lower layer frame that temporally coincides with the at least one upper layer frame area being decoded.

73. The device of claim 72, wherein the intermediary frame is used as a spatial or temporal predictor for the upper layer frame area being decoded.

74. The device of claim 72, wherein the intermediary frame includes an up-sampled version of a decoded lower layer frame.

75. The device of claim 72, wherein the intermediary frame mixes frame areas extracted from a decoded lower layer frame and frame areas extracted from reference frames of the upper layer using prediction information from the lower layer.

76. The device of claim 74 wherein the up-sampling operation allowing obtaining the up-sampled version the decoded lower layer frame is applied on a version of the decoded lower layer frame on which had been applied a SAO filtering using the second SAO parameters.

77. A non-transitory computer-readable medium carrying a program which, when executed by a microprocessor or computer system in a device, causes the device to perform a method of encoding or decoding a scalable video sequence made of at least one lower layer and one upper layer, the method comprising:
decoding a lower layer bitstream to obtain first sample adaptive offset, SAO, parameters defining a first SAO filtering applied to at least one lower layer frame area; and
decoding an upper layer bitstream into at least one decoded upper layer frame area, using a second SAO filtering applied to at least one processed frame area of a processed frame based on respective second SAO parameters;
wherein part or all of the second SAO parameters are inferred from the first SAO parameters.
